(19) United States
(12) Patent Application Publication
(10) Pub. No.: US 2015/0024204 A1
(43) Pub. Date: Jan. 22, 2015

(54) NOVEL PROCESS OF PREPARING NANO METAL AND THE PRODUCTS THEREOF

(71) Applicant: Sudhakara Sastry AMANCHI BALA, Andhra Pradesh (IN)

(72) Inventors: Sudhakara Sastry Amanchi Bala, Secunderabad (IN); Karthik Raghavendra Bhagyaraj Aamanchi, Secunderabad (IN); Koushika Amanchi Vamsi Phanindra, Secunderabad (IN); Aparna Amanchi, Hyderabad (IN)

(21) Appl. No.: 14/370,974

(22) PCT Filed: Jan. 9, 2013
(86) PCT No.: PCT/IB2013/000024

§ 371 Date: Jul. 8, 2014

(30) Foreign Application Priority Data
Jan. 9, 2012 (IN) 83/CHE/2012

(51) Int. Cl. B22F 9/24; C22B 15/00; C01G 3/02; C22B 21/02; C01G 21/02; C22B 3/00; C21B 15/00

(52) U.S. Cl. CPC B22F 9/24; C22B 13/04; C22B 15/0089; C22B 25/04; C21B 15/00; C22B 21/02; C01G 21/02; C01G 3/02; C01P 2004/64
USPC 428/402; 75/371; 75/373; 75/351; 420/563; 420/469; 420/557; 420/8; 420/528; 423/619; 423/604

(57) ABSTRACT

The present invention relates a process of preparing a nanopowder by using a natural source starting material wherein the nano powder is a nano metal or nano alloy or nano metal oxide or nano metal carbide or nano compound or nano composite or nanofluid. The nano product produced by the process has novel properties such as enhanced hardness, antibacterial properties, thermal properties, electrical properties, abrasive resistant, wear resistant, superior frictional properties, sliding wear resistance, enhanced tensile strength, compression strengths, enhanced load bearing capacity and corrosion properties. By virtue of this process the products produced are usable in preparation of thermal fluids, anti-fungal/bacterial/fouling coatings, paints, high strength electrical conductors, high corrosion resistant coatings and alloys, inkjet inks, neutralizing gram positive bacteria, neutralizing gram negative bacteria, motor cycle clutch, rocker arm, solder materials, bearing applications, spring materials, automobile parts, steering wheel joints and coatings, connecting rod, memory enhancing devices, hard disks, pen drives, electronic chips, smart materials, shape memory alloys, add-on materials for composite lamina or laminates of any number.

### TECHNICAL FIELD

The present invention relates to the field of nanotechnology and more particularly to a process of preparing a nanopowder by using a natural source starting material. The nano powder is a nano metal or nano alloy or nano metal oxide or nano metal carbide or nano compound or nano composite or nanofluid.

### BACKGROUND

Nanoparticulate transition metal materials can be obtained in the form of metal nano powders, where the grain size ranges between 5-50 nm and metal nano particles of 1-10 nm size having a relatively narrow size distribution.

Nano structured metal particles have been obtained either by so called “top down methods”, i.e. by the mechanical grinding of bulk metals, or via “bottom-up methods” which rely on the wet chemical reduction of metal salts or, alternatively, the controlled decomposition of metastable organometallic compounds such as metal carbonyls. For the production of nanoparticulate metal colloids a large variety of stabilizers, e.g. donor ligands, polymers, and surfactants, are used to control the growth of the initially formed nanoclusters and to prevent them from agglomeration.

The chemical reduction of transition metal salts in the presence of stabilizing agents to generate zerovalent metal colloids in aqueous or organic media was first published in 1857 by M. Faraday and this approach has become one of the most common and powerful synthetic methods in this field. The first reproducible standard protocols for the preparation of metal colloids (e.g. for 20 nm gold by reduction with sodium citrate) were established by J. Turkevich. He also proposed a mechanism for the stepwise formation of nanoparticles based on nucleation, growth, and agglomeration, which in essence is still valid. Data from modern analytical techniques and more recent thermodynamic and kinetic results have been used to refine this model. In the embryonic stage of the nucleation, the metal salt is reduced to give zerovalent metal atoms. These can collide in solution with further metal ions, metal atoms, or clusters to form an irreversible “seed” of stable metal nuclei. The diameter of the “seed” nuclei can be well below 1 nm depending on the strength of the metal-metal bonds and the difference between the redox potentials of the metal salt and the reducing agent applied. The formation of nanoparticulate metal colloids via “reductive stabilisation” using organo aluminum reagents follows a different mechanism which has been recently elucidated in detail.

During the last few decades a considerable body of knowledge has been accumulated on these materials. Highly dispersed mono- and bimetallic colloids can be used as precursors for a new type of catalyst that is applicable both in the homogeneous and heterogeneous phases. Besides the obvious applications in powder technology, material science and chemical catalysis, recent studies have examined the great potential of nanostructured metal colloids as advantageous fuel cell catalysts.

As per Nanoscience and Nanotechnology in Engineering By Vijay K. Varadan, A. SivathanuPillai, DebashishMukherji, Conventional methods of particle size reduction i.e. nano powder production include milling, grinding, jet milling, crushing, and air micronization, chemical and physical vapor deposition, gas phase porolysis and condensation, electro deposition, cryochemical synthesis and sol-gel methods. There are several drawbacks to these methods. First, they might not accomplish the desired amount of particle size reduction. The second drawback is associated with the physical and chemical properties of the materials undergoing size reduction. Certain compounds are chemically sensitive or thermo-liable, such as explosives, chemical intermediates, or pharmaceuticals which cannot be processed using conventional methods due to the physical effects of these methods.

Other compounds such as, polymers, pigments or dyes, etc. maybe difficult to process by conventional methods due to physical properties such as physical degradation under high pressures or temperatures, “softness”, or waxy texture.

Metal Nano powders: Nano structured metal and alloy powders may be produced either via the reduction or co-reduction of metal salts using alkaline-triorganohydroborates or using the “polyol”- or the “alcohol-reduction” pathways.

TriorganohydroborateReduction: Thetriorganohydroborate reduction of e.g. Pt-salts yields Ptnano powders of ca. 3-4 nm size with purities of >95% . The size distribution, however, is relatively broad and the product is contaminated with small residues of alkaline halides.

Polyol Method: Via the Polyol Method (see equation below) relatively large Pt nanopowders (e.g. 5-13nm) are obtained in >99% purity. The reduction is based on the decomposition of the ethylene glycol and its conversion to diacetyl. N.

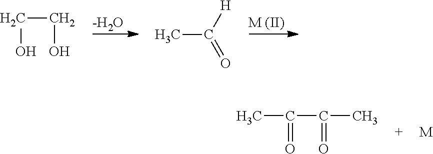

Alcohol Reduction Method: Toshima from the Science University of Tokyo in Yamaguchi has introduced the alcohol reduction method in the field of nanopowder synthesis. Alcohols such as methanol, ethanol or propanol work simultaneously as solvents and as reducing agents, being oxidized to aldehydes or ketones. Refluxing metal salts or complexes (such as H2PtC16, HAuC14, PdC12, RhC13 in an alcohol/water solution (1/1, v/v) yields nanocrystalline metal powders in the absence of stabilizers. In the case of Pt, the alcohol reduction of H2PtC16 gives Pt(0) particles of ≈3 nm size, however with a broad size distribution, and moderate purity (80-90%). It should be mentioned here that in the presence of protective polymers such as polyvinylpyrrolidone (PVP), homogeneous colloidal dispersions, e.g. nanometalPt colloids of 2.7 nm size are obtained.

The basic conventional methods of producing nano powders is labor intensive, requires various machinery, non environment friendly, requires various energy resources and most importantly expensive. Still the nano powders produced by conventional methods may not have the desired nano powder and yield.

### SUMMARY

The present invention describes a process of producing nano powders wherein a natural ingredient is used to produce the nano powder by combining a metal salt with such natural component in a metal container at room temperature.

A novel process of preparing metal nano powders using a natural ingredient selected from the group comprising of herbal extracts, plant extracts, water, milk or milk products, comprising the steps of:
(a) combining the natural ingredient with a metal salt in a metal container;
(b) allowing the nano powder to form and deposit; and
(c) obtaining the nano powder.

### BRIEF DESCRIPTION OF THE DRAWINGS

The features and advantages of this present disclosure, and the manner of attaining them, will become more apparent and will be better understood by reference to the following description of embodiments taken in conjunction with the accompanying drawings wherein

FIG. 1 shows the image of lead nano powder;

FIG. 2 shows graph for purity of lead used for example 2;

FIG. 3 describes XRD of the sample produced in example 4;

FIG. 4 describes XRD of the sample produced in example 5;

FIG. 5 shows XRD pattern of the product of example 6;

FIG. 6 shows XRD Pattern of product of example 7;

FIG. 7 shows the image of nano tin;

FIG. 8 shows XRD Pattern of the product of example 8;

FIGS. 9 and 10 shows XRD patterns of the product of example 9;

FIG. 11 shows XRD pattern of copper-lead nano powder in example 10;

FIG. 12 shows XRD pattern of Cu—Zn nano powder in example 11;

FIG. 13 shows XRD pattern of Al—Cu nano powder in example 12;

FIG. 14 shows XRD pattern of Al—Pb nano powder in example 13;

FIG. 15 shows XRD patterns of Sn—Pb nano powder in example 14;

FIG. 16 shows XRD patterns of Al nano powder in example 15;

FIG. 17 shows XRD pattern of Cu—Zn nano particles in example 16;

FIG. 18 shows XRD pattern of Sn—Cu nano powder in example 19;

FIGS. 19 A, 19 B and 19 C show XRD patterns of the sample produced in example 26 and particle size of the nano copper produced;

FIG. 20 shows XRD patterns of the Al—Cu nano partiles in example 32;

FIG. 21 shows XRD patterns of Al—Pb nano particles in example 33;

FIG. 22 illustrates XRD patterns of Sn—Fe nano particles in example 33;

FIG. 23A shows XRD patterns of copper nano particles in example 42;

FIG. 23B shows the particle size analyser of the copper nano particles;

FIG. 23C shows energy dispersive X-Ray analysis of copper nano particles;

FIG. 24 shows the image of copper nano particles produced by the method described in example 45;

FIG. 25 shows the graph for purity of nano copper particles produced by the method described in example 49;

FIG. 26 shows XRD images as in the peaks of lead and Pb2O3 and Pb3O4 as described in example 50;

FIG. 27 shows XRD image of copper nano particles in example 51;

FIG. 28 shows nano copper powder after sintering at 500° C.;

FIG. 29 shows the wear resistance of the copper nano poweder;

FIG. 30 shows the results of testing electrical conductivity of copper nano particles;

FIG. 31 illustrates the comparative particle size analysis of copper nano particles prepared by ball milled method and vedic method;

FIGS. 32 and 33 show the inoculated plates to measure the antimicrobial activity in Minimum Inhibition Concentration test;

FIG. 34 shows the inoculated plates to measure the antimicrobial activity in Minimum bacterial concentration test;

FIG. 35 A shows the antibacterial activity of copper nano particles on E. Coli;

FIG. 35 B illustrates the graph between Concentration of CU NPs and number of colonies.

FIG. 36 A shows the antibacterial activity of copper nano particles on Bacillus subtilis;

FIG. 36 B illustrates the graph between Concentration of CU NPs and number of colonies.

FIG. 37 A shows the antibacterial activity of copper nano particles on Staphilococcus aureus;

FIG. 37 B illustrates the graph between Concentration of CU NPs and number of colonies.

FIGS. 38 and 39 show the MTTT assay for copper nano particles prepared by ball milled method and vedic method;

FIG. 40 illustrates the graph indicating comparative MTT assay of copper nano particles prepared by ball milled method and vedic method;

FIG. 41 illustrates the cyto-toxicity comparison of copper nano particles prepared by ball milled and vedic method;

FIGS. 42 shows the XRD results of ball milled copper nano particles;

FIG. 43 shows XRD results of vedic copper nano particles;

FIG. 44 shows the compression between ball milled and vedic copper nano particles;

FIG. 45 illustrates the particle size analysis of ball milled and vedic copper nano particles;

FIG. 46 A and B show the SEM results of ball milled and vedic copper nano particles respectively;

FIGS. 47 and 48 show the EDX spectra for vedic nano partilcles of ball milled and vedic copper nano particles; and

FIGS. 49 and 50 illustrate the UV-Vis spectra of ball milled and vedic copper nano particles respectively.

### DETAILED DESCRIPTION OF THE INVENTION

Reference will now be made in detail to the exemplary embodiment(s) of the invention, examples of which are illustrated in the accompanying drawings. Whenever possible, the same reference numerals will be used throughout the drawings to refer to the same or like parts.

In this document, the terms “comprises,” “comprising,” or any other variation thereof, are intended to cover a non-exclusive inclusion, such that a process, method, article, device or apparatus that comprises a list of elements does not include only those elements but may include other elements not expressly listed or inherent to such process, method, article, device, or apparatus. An element proceeded by “comprises . . . a” does not, without more constraints, preclude the existence of additional identical elements in the process, method, article, device or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

The present invention may be obtained by using the following tabulated herbs:

| S.NO | SCIENTIFIC NAMES | COMMON NAMES |
|---|---|---|
| 1 | Curcuma aromatic | Aranyaharidra, Vamaharidra |
| 2 | Alpiniacalcarta | |
| 3 | Indigiferatinctoria | Nilika |
| 4 | Spilanthusacmella | Maratiteega |
| 5 | Pelargonium gravcolens | Geranium |
| 6 | Mirabilis jalapa | Krishna kelli, sandhya raga |
| 7 | Withanaisomnifera | Aswagandha |
| 8 | Bacopamonnuri | Brahmi |
| 9 | Centellaasiastica | Mandukaparni |
| 10 | Rauvolfia serpentine | Sarpagandha |
| 11 | Acoruscalamus | Vacha |
| 12 | Andrographispaniculata | Bhunimbah |
| 13 | Zingiberofficinale | Adraakam |
| 14 | Cissusrepens | Nalleru |
| 15 | Apiumgraveolens | Ulery |
| 16 | Steaviarebaudiania | |
| 17 | Caralluma umbellate | |
| 18 | Jatropha multi fida | Bhadradanthi |
| 19 | Symplocosracemosus | Lodhra |
| 21 | Cymbopogonwinterianus | Java citronella |
| 22 | Curcuma longa | Haridra |
| 23 | Abelmoschusmoschatus | Kasturibenda |
| 24 | Mucuna cochin | Chinensis |
| 25 | Daturametel | Dhatturah |
| 26 | Helectersisora | Avarttani |
| 27 | Tinosporatomentos | Kotimolateega |
| 28 | Desmodiumgangeticum | |
| 29 | Ipomoea balatas | Raktaluh |
| 30 | Scillahyacinthiana | Adavitellagadda |
| 31 | Plumbagozeylanica | Tellachitrmulam |
| 32 | Marjoranahortensis | Maruvam |
| 33 | Notoniagrandiflora | Kundeluchevi-aku |
| 34 | Plectranthusambonicus | Sugandhavalakam |
| 35 | Menthe piperita | Pepper mint |
| 36 | Costusspeciosus | Chanda |
| 37 | Rutachalepensis | Gycchapatra |
| 38 | Alpiniagalangal | Sugandhamula |
| 39 | Kaempferia rotunda | Bhumichampaka |
| 40 | Aremisia vulgaris | Nagadhamani |
| 41 | Anisomelesmalabarica | Vaikuntah |
| 42 | Aristolochiabracteolate | Kitamari |
| 43 | Vincarosea | Billaganneru |
| 44 | Elettariacadamomum | Ela, yalakalu |
| 45 | Calotropisprocera | Arkah |
| 46 | Psoraleacorylifolia | Bakuchi |
| 47 | Paederiafortida | |
| 48 | Riveahypocrateriformis | Boddikura |
| 49 | Ichnocarpusfrutescens | Nallateega |
| 50 | Piper longum | Pippali |
| 51 | Aeglemarmelos | Sriphalah |
| 52 | Opuntiadillenii | Vidara visa vasaraka |
| 53 | Euphirbiatirucalli | Trikantaka |
| 54 | Souropsandrogynus | Multi vitamin |
| 55 | Tylophoraindica | Antamu |
| 56 | Adhatodazeylanica | Sinhaparni |
| 57 | Asparagus racemosus | Satavari |
| 58 | Abrusprecatorius | Gunja |
| 59 | Phyllanthusamarus | Bahupatra |
| 60 | Vativerizizanioides | Vettiver |
| 61 | Tinosporacordifolia | Guduchi |
| 62 | Gymnemasylvestre | Madhuvasini |
| 63 | Acimumtenuiflorum | Surasa, Krishna tulsi |
| 6 | Nyctanthes arbor tritis | Parijatah |
| 65 | Aratbotryshexapetalus | Harichampa |
| 66 | Phonixdactylifera | Kharjurah |
| 67 | Pandanusodoratissimus | Kataki |
| 68 | Cassia alata | Mettatamara |
| 69 | Ocimumbasilicum | Barbari |
| 70 | Alangiumsalnifolium | Ankola |
| 71 | Carissa carandas | Kanachuka, karamarda |
| 72 | Jatrophagossypifolia | Nikumba |
| 73 | Lawsoniainermis | Madyantika |
| 74 | Bixaorellana | Sinduri |
| 75 | Mimosa pudica | Lajjalu |
| 76 | Commiphoramukul | Guggulu |
| 77 | Buteamonosperma | Palasah, moduga |
| 78 | Piper betle | Tambulavalli, nagulavalli |
| 79 | Daturafatuosa | Nallaummetha |
| 80 | Aervalanta | Bhadra, pashanabheda |
| 8 | Stachytarphetajamaicensis | Brazilian tree |
| 82 | Area catechu | Puguh |
| 83 | Stachytarpheta | Brazilian tree |
| 84 | Cocculushirsutus | Sibbiteega |
| 85 | Ocimumgratissimum | Lavangatulasi |
| 86 | Solanumnigrum | Kamanchi |
| 87 | Ecliptaprostrate | Bhringaraj |
| 88 | Cissusquadragulasis | Asti sandhana, nalleru |
| 89 | Aloe vera | Kumara |
| 90 | Curcuma amada | Amrardrakam |
| 91 | Curculigiorchioides | Nelatatigadda |
| 92 | Leptadenia reticulate | Jivanti |
| 93 | Justiciagendarussa | Nilanirgundi |
| 94 | Ocimum sanctum | Tulasi |
| 95 | Celastruspaniculate | Jyothishmati |
| 96 | Passifloaedulus | Passion fruits |
| 97 | Vitexpurpurescense | Nellivavili |
| 98 | Holostemmeadakodien | Jivati |
| 99 | Achyranthusaspera | Apamarga |
| 100 | Gmelinaarborea | Gambhari, kasamari |
| 101 | Oroxylumindicum | Syonakah, tuntukah |
| 102 | Stereospermumsuaveolens | Kuberaakshi |
| 103 | Bauhinia variegate | Kavidara, devakanchanamu |
| 104 | Caesalpiniasappan | Patrangah, pattavanjaka |
| 105 | Givotiarotteleriformis | Tellapoliki |
| 106 | Cordial dichotoma | Iriki |
| 107 | Adina cordifolia | Haldu, turmeric wood |
| 108 | Baringtoriaacutangula | Kanap, Indian oak |
| 109 | Hard wickiabinata | Nara yepi |
| 110 | Dalbergialatifolia | Sispa, jittegi |
| 111 | Ficustomentosa | Juvvi |
| 112 | Holarrhenapubescens | Kutaja, kodisapala |
| 113 | Bosnelliaserata | Palasha |
| 114 | Couroupitaguianens | Naga lingam |
| 115 | Albiziaodoratissima | Bhusirisah |
| 116 | Plerocarpusmarsupium | Asanahm, bijakah |
| 117 | Hymenodictyonexcelsum | Dudippa |
| 118 | Litseaglutinosa | Nara mamidi |
| 119 | Mitragynaparvifolia | Vitanah |
| 120 | Cochlnospermumreligiosum | Girisalmalka, silakarpasika |
| 121 | Dichrostachyscinerea | Vellantara |
| 122 | Syzygiumcumini | Jambuh |
| 123 | Crescentiacujette | Kamandalamuchettu |
| 125 | Ficuscarica | Anjira |
| 126 | Prosopis cineraria | Jammu chettu |
| 127 | Morindacitri folia | Asyuka |
| 128 | Pterocarpusofficinalis | All species |
| 129 | Abutilon indicum | Tutturbenda |
| 130 | Cinnamomumzeylanium | Tamalapatra |
| 131 | Cymbopogonfexuosus | Lemon grass |
| 132 | Citrus medica | Matutunga |
| 133 | Semecarpusanacardium | Bhallatakah |
| 134 | Clitoriaternatea | Aparajitha |
| 135 | Decalepishamiltonii | Maredugaddalu |
| 136 | Rosemarinusofficinalis | Rose mary |
| 137 | Rauwolfia tetra ohylla | Papataaku |
| 138 | Jasminumsambac | Mallika |
| 139 | Elaeocarpusganitrus | Rudraksha |
| 140 | Saracaasoca | Ashokamu, vanjulamu |
| 141 | Terminaliabellerica | Vibhitakah |
| 142 | Terminaliachebula | Haritak |
| 144 | Sterculiaurens | Tapsi, kateera gum |

The present invention may also be obtained by using the following tabulated plants:

| ACID | | | |
|---|---|---|---|
| NAMES | COMMON NAMES | SCIENTIFIC NAMES | PLANTS NAMES |
| Carboxylic | Uttareni | Amaranthaceae | Wheat, Watermelon, Mango, |
| acid | | | Brinjal, Paddy, Sugarcane, |
| | | | potato, pomegranate, Rose, |
| | | | citrus |
| | Geranium | pelargonium | |
| Phenolic | Samambaia | Polypodiumleucotomos | Choke berry, blue berry, |
| acid | | | plum, cherry, apple, |
| | | | sweetrowen berry |
| | Quince | Cyndoniaoblonga | |
| | Aolevera | Aloe ferox | |
| Chorogenic | Black berry, | Vaccinumangustifolium | Sunflower seeds, potatoes, |
| acid | | | tomatoes, apple, peas, tobacco |
| | Magnoliopsida | Dicotyledonous | |
| | Honeysuckle | Loniceramaacki | |
| Shikimic | Star anise | Illiciumverum | Wheat, tomato, cotton |
| acid | | | |
| | Black berry | Vaccinumangustifolium | |
| Tartaric | Tamarind | Tamarindusindica | Banana, grapes |
| acid | | | |
| Ascorbic | Amla | Emblicaofficinalis | Pepper, dog rose |
| acid | | | |
| Citric acid | Lemon | Citrus auratium | Orange, grapes, tangerines |
| Lactic acid | Butter milk | | |
| Saponin | Soap nut | Sapindusmukorossi | Soy beans, peas, Joshua tree |
| Amino | Enugupalleru, | Tribulusterrestris | Corn, potatoes and beans |
| acids | peddapale riu, | | |
| | Enugapallerumulla | | |
| Linoleic | Garudamukku, | | Sunflower, carrot, tobacco |
| acid | telukondicchhettu | | |
| Malvalic | | | Cotton, |
| acid | | | |
| Oleic acid | | | Palm, soy bean |
| Palmitic | | | Palm, soybean, corn, pea nuts |
| acid | | | |
| Arachidic | | | Safflower, corn, soy bean, |
| acid | | | sun flower. |

Also potable water or de-mineralized water or water with any amount of minerals/salts may be used as starting material. Apart from the above, milk or milk products may also be used. Further the starting material may be used in powder or paste or juice form or in its original form or mixed with water or any other ingredient. Also the natural source may be used either solely or in combination with any or all of the natural sources described above.

The process produces nano materials of Size: 10 nm-100 nm having purity Purity: 98-100% and the yield is 70-99%. The process comprises of combining one or more starting materials with a metal salt. The metal salt contains any of the metals as given below as the metal component. C, Mg, Al, Si, Ti, Cr, Mn, Fe, Co, Ni, Cu, Zn, Y, Zr, Ag, Cd, Sn, Sb, W, Au, Hg, Pb or Bi group metals.

The metal salt is an oxide or a sulfide or a silicate or a nitrate or a nitride or a sulphate or a chloride or any other metal salt of the metals C, Mg, Al, Si, Ti, Cr, Mn, Fe, Co, Ni, Cu, Zn, Y, Zr, Ag, Cd, Sn, Sb, W, Au, Hg, Pb or Bi or alloys thereof or bimetals thereof. The process is carried on in a metal container made of the metals C, Mg, Al, Si, Ti, Cr, Mn, Fe, Co, Ni, Cu, Zn, Y, Zr, Ag, Cd, Sn, Sb, W, Au, Hg, Pb or Bi alloys thereof or bimetals thereof.

The process of present invention contains steps of adding a metal salt to the natural component till nano metal or nano alloy, nano metal oxide or nano metal carbide or nano compound or nano composite or nano fluidis deposited and then collecting it and washing it until impurities are cleaned. Also further washing is done with a chemical rich in citric acid to remove impurities and oxides. Vacuum drying the powder is done and obtaining the end product by known methods.

The product produced by the process given above has surprisingly produced nano products with enhanced properties. Also the nano product produced by the present process is organic in nature and contains an organic compound by way of coating.

### EXAMPLES

### Example 1

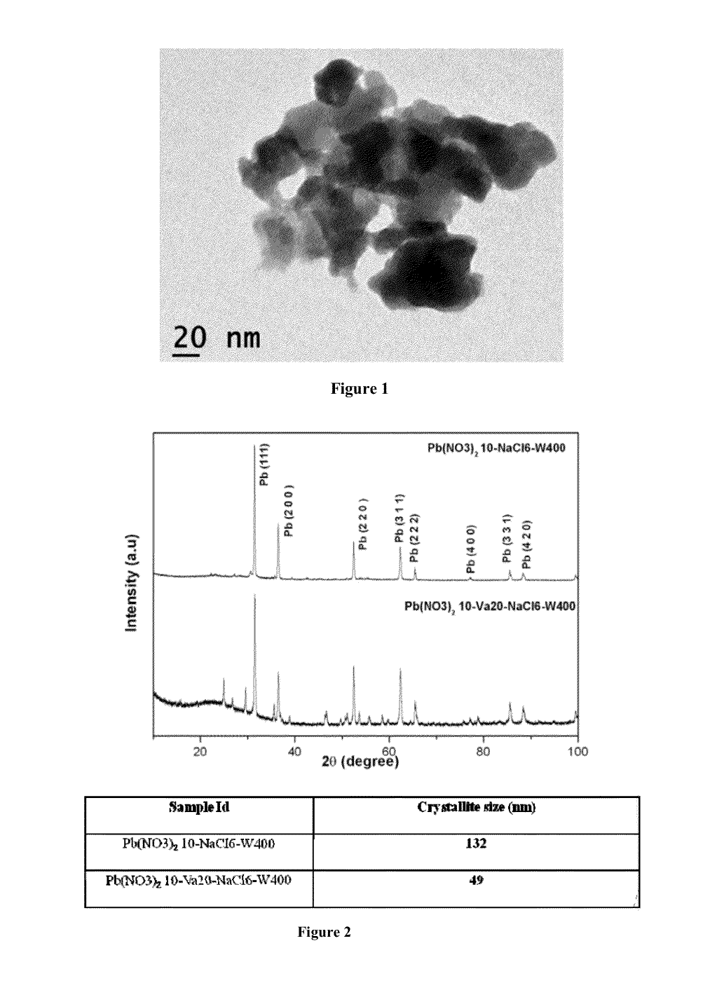

10 grams of lead nitrate is taken in the container of Aluminium. In this 4 gm of tamarind is added. After 15 minutes, lead nano powder is deposited in the container giving yield of 30%. Then this powder is washed by lime juice to get a purity of 100%. The size of the lead nano particles are measured and found to be 80 nm. FIG. 1 shows the image of lead nano powder.

Pb 10-TJ4-W400-Nac16-L

### Example 2

10 grams of lead nitrate is taken in the container of Aluminium. In this 20 gm of kupenta is added. After 15 minutes, lead nano powder is deposited in the container giving yield of 30%. Then this powder is washed by lime juice to get a purity of 100%. The size of the lead nano particles are measured and found to be 96 nm. FIG. 2 shows graph for purity of lead used for such example.

Pb 10-kp20-W400-Nac16-L

### Example 3

70 grams of lead nitrate is taken in the container of Aluminium. In this 20 ml of brungaraj is added. After 15 minutes, lead nano powder is deposited in the container giving yield of 80%. Then this powder is washed by lime juice to get a purity of 100%. The size of the lead nano particles are measured and found to be 113 nm.

### Example 4

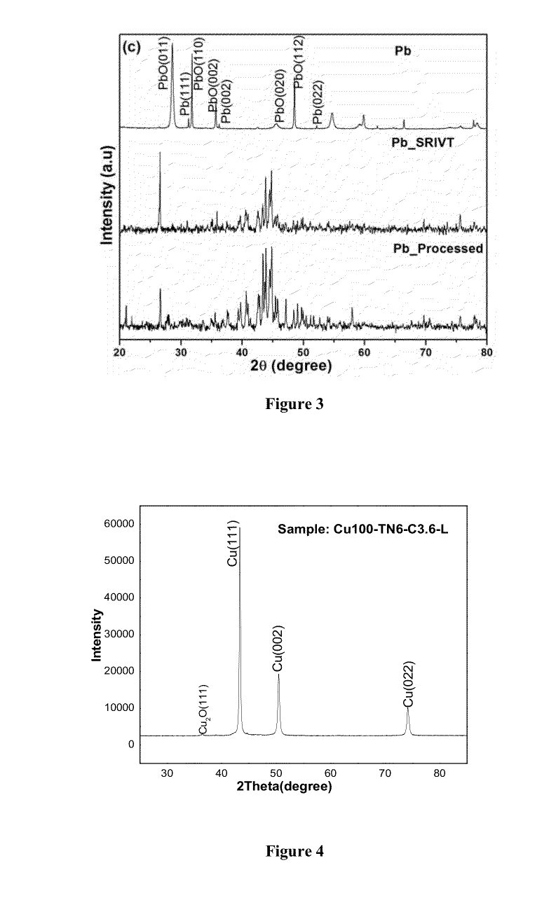

10 grams of lead nitrate is taken in the container of Aluminium and added with water. After 15 minutes, lead nano powder is deposited in the container giving yield of 93%. Then this powder is washed by lime juice to get a purity of 100%. The size of the lead nano particles are measured and found to be 132 nm. FIG. 3 describes XRD of the sample produced in this example.

Pb 10-W400-Nac16-L

### Example 5

100 grams of copper sulphate is taken in the container of Aluminium. 72 gm of Ruta chalepensis is added. After 15 minutes, copper nano powder is deposited in the container giving yield of 93%. Then this powder is washed by lime juice to get a purity of 98.7%. The size of the copper nano particles are measured and found to be 51.8 nm. FIG. 4 describes XRD of the sample produced in this example.

### Example 6

100 grams of copper sulphate is taken in the container of Aluminium. 72 gm of Mirabilis jalapa is added. After 15 minutes, copper nano powder is deposited in the container giving yield of 90%. Then this powder is washed by lime juice to get a purity of 94.4%. The size of the copper nano particles are measured and found to be 24.4 nm. FIG. 5 shows XRD pattern of the product of this example.

### Example 7

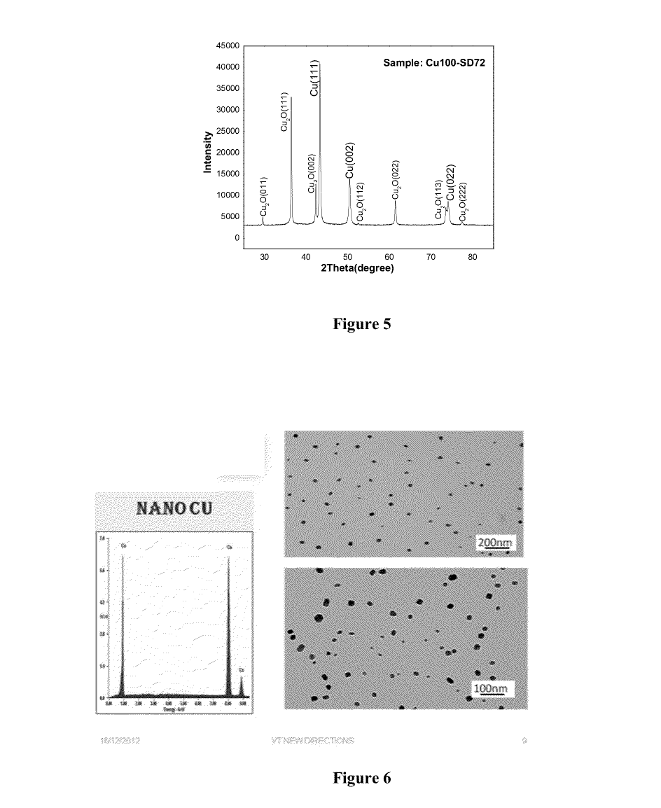

100 grams of copper sulphate is taken in the container of Aluminium. 72 gm of Acorns calamus is added. After 15 minutes, copper nano powder is deposited in the container giving yield of 60%. Then this powder is washed by lime juice to get a purity of 99%. The size of the copper nano particles are measured and found to be 35.2 nm. FIG. 6 shows XRD Pattern of product of this example.

### Example 8

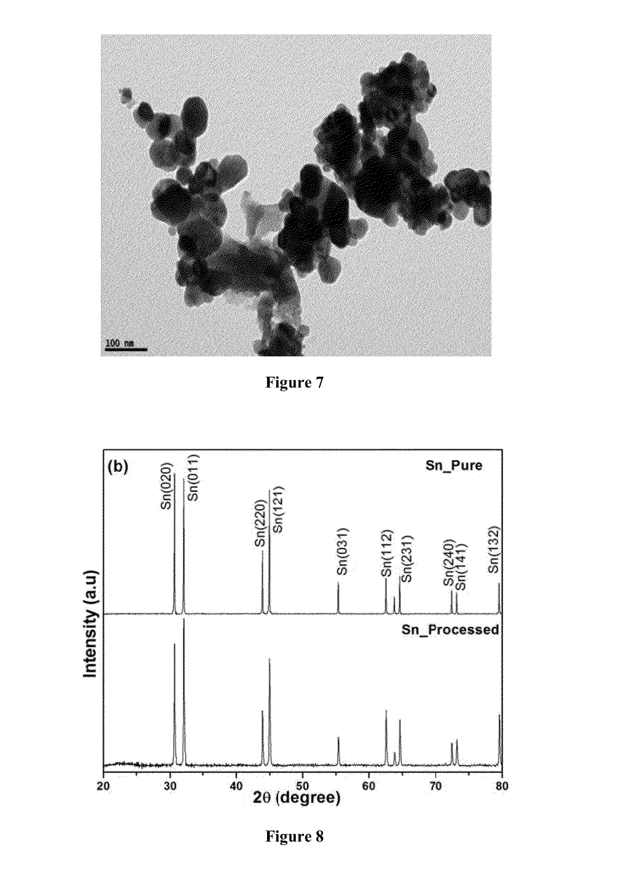

10 grams of tin powder is taken in the container of Aluminium. 8 gm of tamarind is added. After 15 minutes, tin nano powder is deposited in the container giving yield of 60%. Then this powder is washed by lime juice to get a purity of 99%. The size of the tin nano particles are measured and found to be 100 nm. FIG. 7 shows the image of nano tin and FIG. 8 shows XRD Pattern of the product of this example.

Sn10-tj8-W200-L

### Example 9

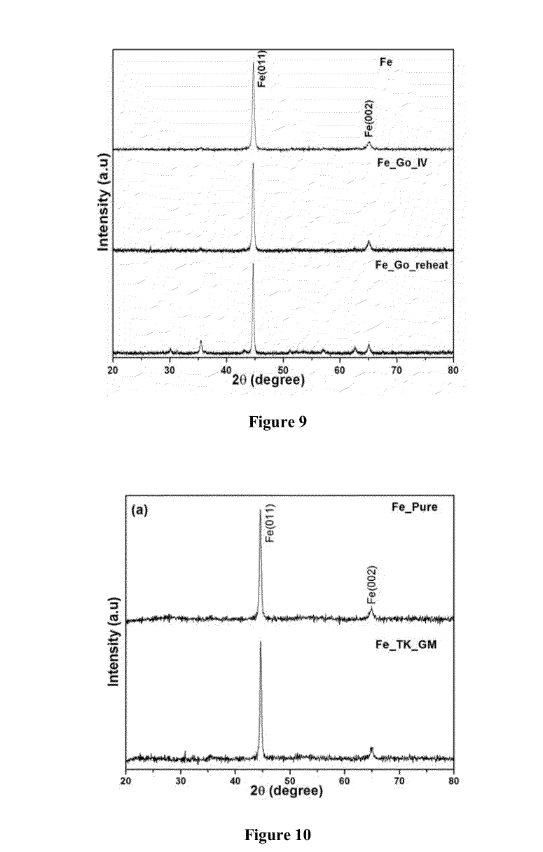

10 grams of iron powder is taken in the container of Aluminium. 8 gm of tamarind is added. After 15 minutes, iron nano powder is deposited in the container giving yield of 60%. Then this powder is washed by lime juice to get a purity of 98.7%. The size of the iron nano particles are measured and found to be 50 nm. FIGS. 9 and 10 shows XRD patterns of the product of this example.

### Example 10

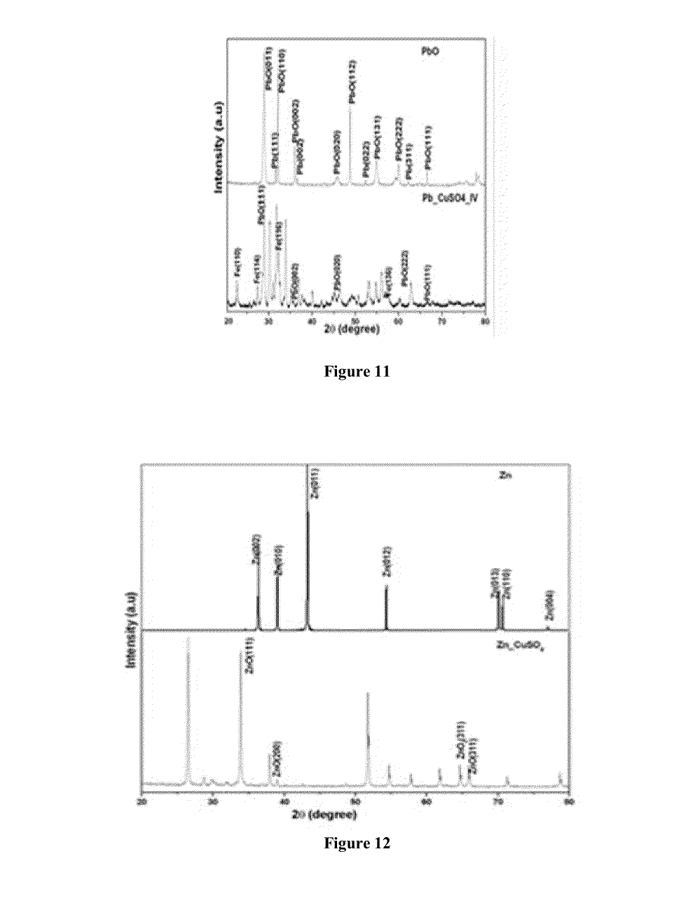

10 grams of copper sulphate and lead sulpahate are taken in the container of Aluminium. 8 gm of tamarind is added. After 15 minutes, Cu—Pb nano powder is deposited in the container giving yield of 70%. Then this powder is washed by lime juice to get a purity of 98.7%. The size of Cu—Pb nano particles are measured and found to be 30 nm. FIG. 11 shows XRD pattern of copper-lead nano powder.

### Example 11

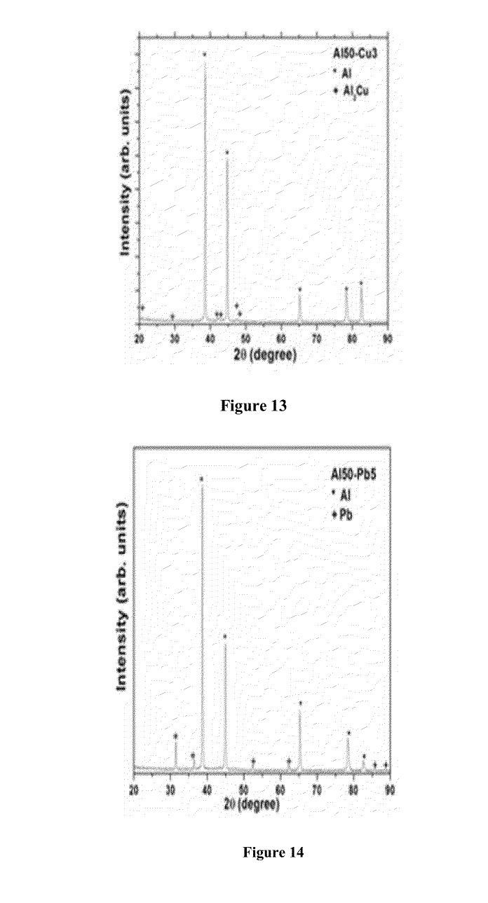

30 grams of copper sulphate and zinc sulphate are taken in the container of Aluminium. 10 gm of Caralluma umbellate is added. After 10 minutes, Cu—Zn nano powder is deposited in the container giving yield of 60%. Then this powder is washed by lime juice to get a purity of 98.7%. The size of the Cu—Zn nano particles are measured and found to be 60 nm. FIG. 12 shows XRD pattern of Cu—Zn nano powder.

### Example 12

10 grams of aluminum sulphate and copper sulphate are taken in the container of Aluminium. 4 gm of Symplocos racemosus is added. After 15 minutes, Al Cu nano powder is deposited in the container giving yield of 60%. Then this powder is washed by lime juice to get a purity of 98.7%. The size of the Al Cu nano particles are measured and found to be 40 nm. FIG. 13 shows XRD pattern of Al—Cu nano powder.

### Example 13

10 grams of aluminum sulphate and lead sulphate are taken in the container of Aluminium. 4 gm of Abelmoschus moschatus is added. After 15 minutes, Al—Pb nano powder is deposited in the container giving yield of 70%. Then this powder is washed by lime juice to get a purity of 99%. The size of the Al Pb nano particles are measured and found to be 60 nm. FIG. 14 shows XRD pattern of Al—Pb nano powder.

### Example 14

10 grams of tin powder and lead sulphate are taken in the container of Aluminium. 4 gm of Marjoram hortensis is added. After 15 minutes, Sn—Pb nano powder is deposited in the container giving yield of 80%. Then this powder is washed by lime juice to get a purity of 99.4%. The size of the Sn—Pb nano particles are measured and found to be 60 nm. FIG. 15 shows XRD patterns of Sn—Pb nano powder.

### Example 15

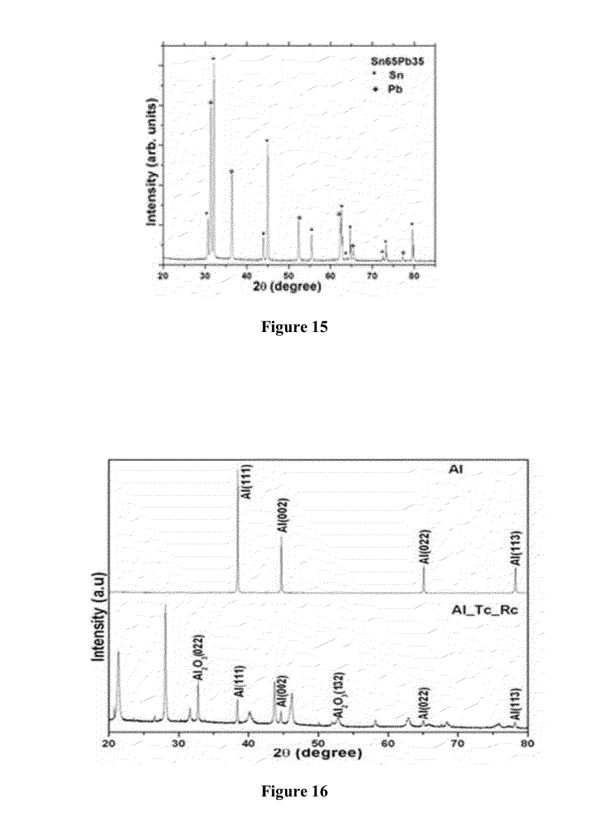

20 g of aluminum pieces are taken in an iron vessel and boiled in tumma chekka kashayam for 3 hrs, ravi chekka kashayam for 1 hr later. Approximately 10 g of apamarga extract is added and mixed continuously till the metal mixes equally with the apamarga extract. Aluminum becomes a black & fine powder. After 15 minutes, Al nano powder is deposited in the container giving yield of 80%. Then this powder is washed by lime juice to get a purity of 99.4%. The size of the Al nano particles are measured and found to be 60 nm. FIG. 16 shows XRD patterns of Al nano powder.

### Example 16

10 grams of copper sulphate and zinc sulphate are taken in the container of Aluminum. 4 gm of Alpinia galangal is added. After 15 minutes, Cu Zn nano powder is deposited in the container giving yield of 80%. Then this powder is washed by lime juice to get a purity of 99.7%. The size of the Cu—Zn nano particles are measured and found to be 30 nm. FIG. 17 shows XRD pattern of Cu—Zn nano particles.

### Example 17

40 grams of copper sulphate and lead sulphate are taken in the container of Aluminium. 15 gm of Kaempferia rotunda is added. After 15 minutes, Cu—Pb nano powder is deposited in the container giving yield of 80%. Then this powder is washed by lime juice to get a purity of 98%. The size of the Cu Pb nano particles are measured and found to be 50 nm.

### Example 18

40 grams of tin powder and zinc sulphate are taken in the container of Aluminium. 15 gm of Elettaria cadamomum is added. After 15 minutes, Sn—Zn nano powder is deposited in the container giving yield of 70%. Then this powder is washed by lime juice to get a purity of 99%. The size of the Sn—Zn nano particles are measured and found to be 60 nm.

### Example 19

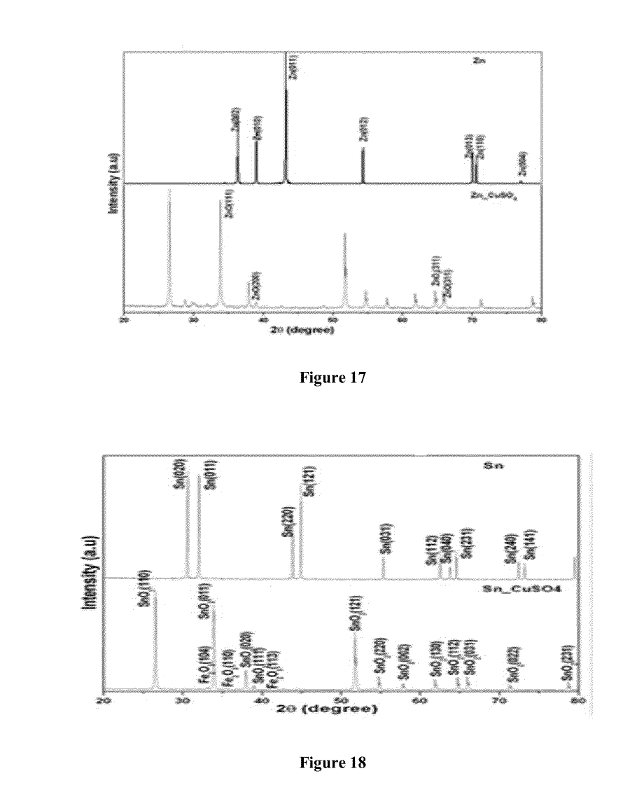

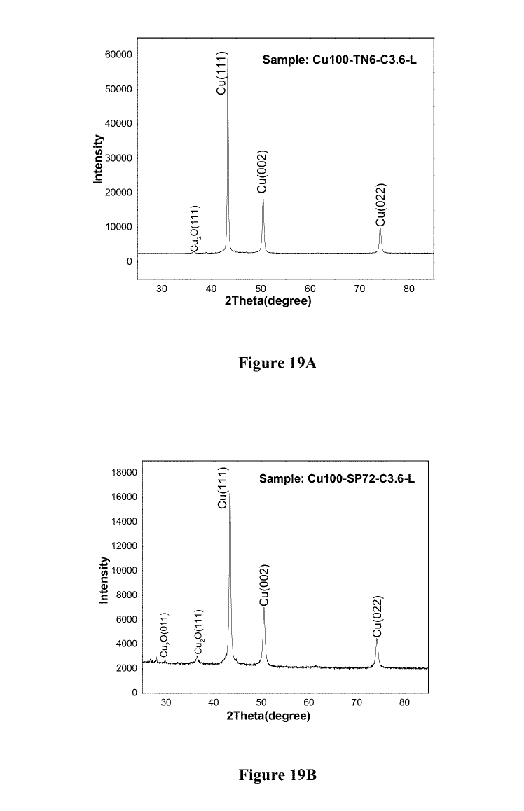

20 grams of tin powder and copper sulphate are taken in the container of Aluminium. 7 gm of Psoralea corylifolia is added. After 15 minutes, Sn—Cu nano powder is deposited in the container giving yield of 80%. Then this powder is washed by lime juice to get a purity of 99%. The size of the Sn—Cu nano particles are measured and found to be 40 nm. FIG. 18 shows XRD pattern of Sn—Cu nano powder.

### Example 20

20 grams of tin powder and ferrous sulphate are taken in the container of Aluminium. 7 gm of Rivea hypocrateri formis is added. After 15 minutes, Sn—Fe nano powder is deposited in the container giving yield of 70%. Then this powder is washed by lime juice to get a purity of 99%. The size of the Sn—Fe nano particles are measured and found to be 30 nm.

### Example 21

100 grams of copper sulphate is taken in the container of Aluminium. 20 gm of curd is added. After 15 minutes, copper nano powder is deposited in the container giving yield of 98%. Then this powder is washed by lime juice to get a purity of 96%. The size of the copper nano particles are measured and found to be 93 nm.

### Example 22

25 grams of copper sulphate is taken in the container of Aluminium. 15 ml butter milk is added. After 15 minutes, copper nano powder is deposited in the container giving yield of 98%. Then this powder is washed by lime juice to get a purity of 99%. The size of the copper nano particles are measured and found to be 81 nm.

### Example 23

100 grams of copper sulphate is taken in the container of Aluminium. 1000 ml water and 30 ml lime juice is added. After 15-30 minutes, copper nano powder is deposited in the container giving yield of 92%. Then this powder is washed by lime juice to get a purity of 100%. The size of the copper nano particles are measured and found to be 122 nm.

### Example 24

50 grams of copper sulphate is taken in the container of Aluminium. 1000 ml water and 30 ml lime juice is added. After 15 minutes, copper nano powder is deposited in the container giving yield of 91%. Then this powder is washed by lime juice to get a purity of 94%. The size of the copper nano particles are measured and found to be 57 nm.

### Example 25

100 grams of copper sulphate is taken in an iron vessel. 7.4 ml amla & 72 ml of soap nut are added to the sample. After 15 minutes, copper nano powder is deposited in the container giving yield of 79%. Then this powder is washed by lime juice to get a purity of 100%. The size of the copper nano particles are measured and found to be 37 nm.

### Example 26

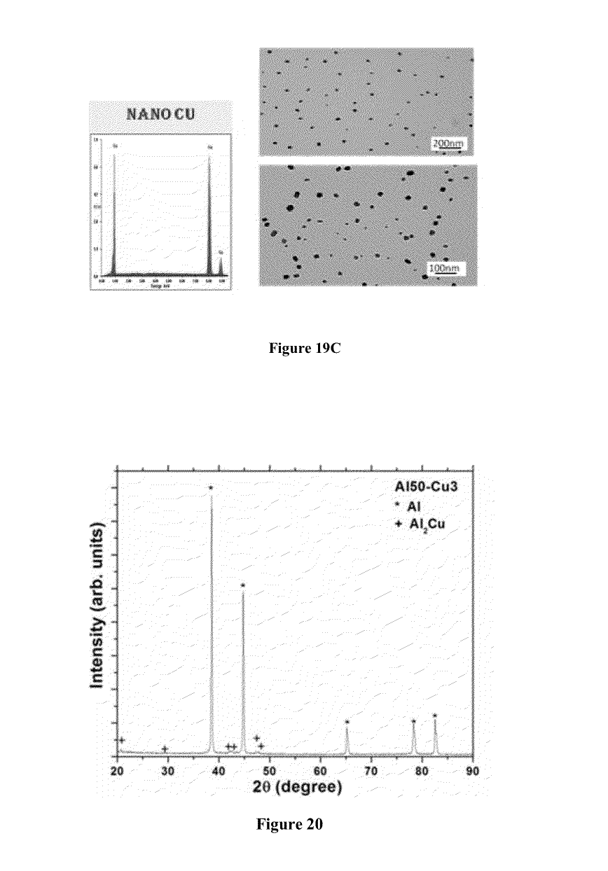

100 grams of copper sulphate is taken in the container of Aluminium. 7.4 ml amla is added. After 15 minutes, copper nano powder is deposited in the container giving yield of 93%. Then this powder is washed by lime juice to get a purity of 100%. The size of the copper nano particles are measured and found to be 70 nm. FIGS. 19 (a), (b) and (c) show XRD patterns of the sample produced in this example and particle size of the nano copper produced.

### Example 27

10 grams of aluminium sulphate and copper sulphate are taken in the container of Aluminium. 4 gm of Nilika is added. After 15 minutes, Al Cu nano powder is deposited in the container giving yield of 60%. Then this powder is washed by lime juice to get a purity of 98.7%. The size of the Al—Cu nano particles are measured and found to be 40 nm.

### Example 28

10 grams of aluminium sulphate and lead sulphate are taken in the container of Aluminium. 4 gm of Maratiteega is added. After 15 minutes, Al—Pb nano powder is deposited in the container giving yield of 70%. Then this powder is washed by lime juice to get a purity of 99%. The size of the Al—Pb nano particles are measured and found to be 60 nm.

### Example 29

10 grams of copper sulphate and zinc sulphate is taken in the container of Aluminium. 4 gm of Krishna kelli is added. After 15 minutes, Cu—Zn nano powder is deposited in the container giving yield of 80%. Then this powder is washed by lime juice to get a purity of 99.7%. The size of the Cu—Zn nano particles are measured and found to be 30 nm.

### Example 30

40 grams of copper sulphate and lead sulphate are taken in the container of Aluminium. 15 gm of Aswagandha is added. After 15 minutes, Cu—Pb nano powder is deposited in the container giving yield of 80%. Then this powder is washed by lime juice to get a purity of 98%. The size of the Cu—Pb nano particles are measured and found to be 50 nm.

### Example 31

20 grams of tin powder and copper sulphate are taken in the container of Aluminium. 7 gm of Mandukaparni is added. After 15 minutes, Sn—Cu nano powder is deposited in the container giving yield of 80%. Then this powder is washed by lime juice to get a purity of 99%. The size of the Sn—Cu nano particles are measured and found to be 40 nm.

### Example 32

30 grams of Al & Cu sulphates are taken in the container of Aluminium. 7 gm of Vacha is added. After 15 minutes, Al—Cu nano powder is deposited in the container giving yield of 70%. Then this powder is washed by lime juice to get a purity of 99%. The size of the Al Cu nano particles are measured and found to be 40 nm. FIG. 20 shows XRD patterns of the Al—Cu nano partiles.

### Example 33

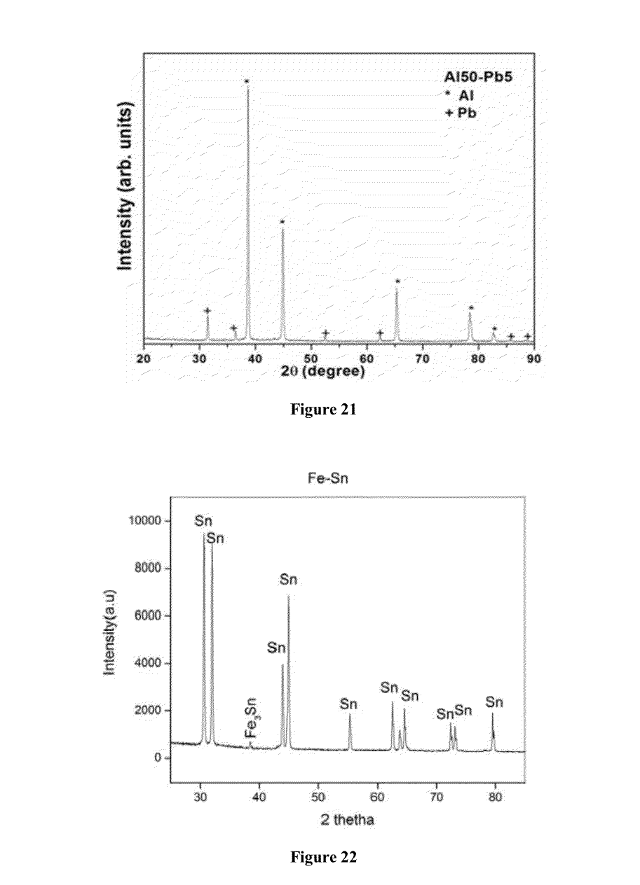

30 grams of Al & Pb sulphates are taken in the container of Aluminium. 7 gm of Bhunimbah is added. After 15 minutes, Al—Pb nano powder is deposited in the container giving yield of 80%. Then this powder is washed by lime juice to get a purity of 99%. The size of the Al Pb nano particles are measured and found to be 30 nm. FIG. 21 shows XRD patterns of Al—Pb nano particles.

### Example 34

20 grams of Fe & Pb sulphates are taken in the container of Aluminium. 7 gm of Adriana is added. After 15 minutes, Fe—Pb nano powder is deposited in the container giving yield of 80%. Then this powder is washed by lime juice to get a purity of 99%. The size of the Fe—Pb nano particles are measured and found to be 47 nm.

### Example 35

20 grams of Cu & Zn sulphates are taken in the container of Aluminium. 7 gm of Nalleru is added. After 15 minutes, Cu—Zn nano powder is deposited in the container giving yield of 80%. Then this powder is washed by lime juice to get a purity of 99%. The size of the Cu Zn nano particles are measured and found to be 40 nm.

### Example 36

20 grams of tin powder and lead sulphates are taken in the container of Aluminium. 7 gm of Ulery is added. After 15 minutes, Sn Pb nano powder is deposited in the container giving yield of 70%. Then this powder is washed by lime juice to get a purity of 99%. The size of the Sn—Pb nano particles are measured and found to be 20 nm.

### Example 37

20 grams of tin powder and ferrous sulphates are taken in the container of Aluminium. 7 gm of Bhadradanthi is added. After 15 minutes, Sn—Fe nano powder is deposited in the container giving yield of 60%. Then this powder is washed by lime juice to get a purity of 99%. The size of the Sn—Fe nano particles are measured and found to be 30 m. FIG. 22 illustrates XRD patterns of Sn—Fe nano particles.

### Example 38

20 grams of Al & Cu sulphates are taken in the container of Aluminium. 7 gm of Lodhra is added. After 15 minutes, Al—Cu nano powder is deposited in the container giving yield of 70%. Then this powder is washed by lime juice to get a purity of 98%. The size of the Al Cu nano particles are measured and found to be 35 nm.

### Example 39

20 grams of Al & Pb sulphates are taken in the container of Aluminium. 7 gm of Java citronella is added. After 15 minutes, Al Pb nano powder is deposited in the container giving yield of 60%. Then this powder is washed by lime juice to get a purity of 98%. The size of the Al Pb nano particles are measured and found to be 37 nm.

### Example 40

20 grams of Fe & Pb sulphates are taken in the container of Aluminium. 7 gm of Haridra is added. After 15 minutes, Fe—Pb nano powder is deposited in the container giving yield of 70%. Then this powder is washed by lime juice to get a purity of 99%. The size of the Fe—Pb nano particles are measured and found to be 30 nm.

### Example 41

20 grams of Cu & Zn sulphates are taken in the container of Aluminium. 7 gm of Kasturibenda is added. After 15 minutes, Cu—Zn nano powder is deposited in the container giving yield of 70%. Then this powder is washed by lime juice to get a purity of 99%. The size of the Cu Zn nano particles are measured and found to be 40 nm.

### Example 42

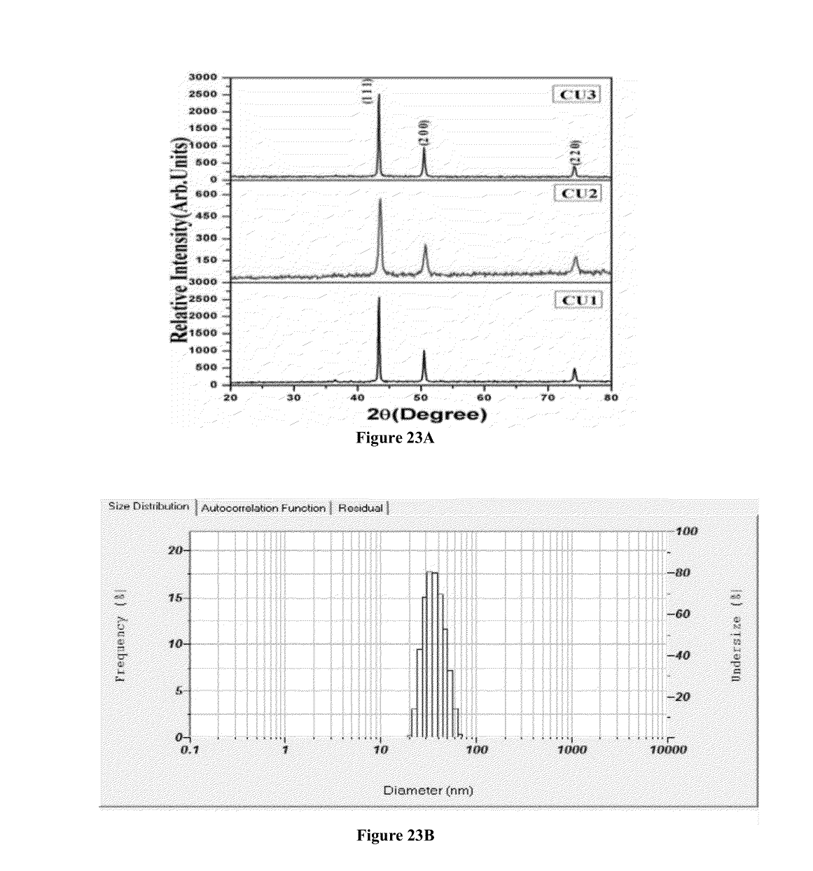

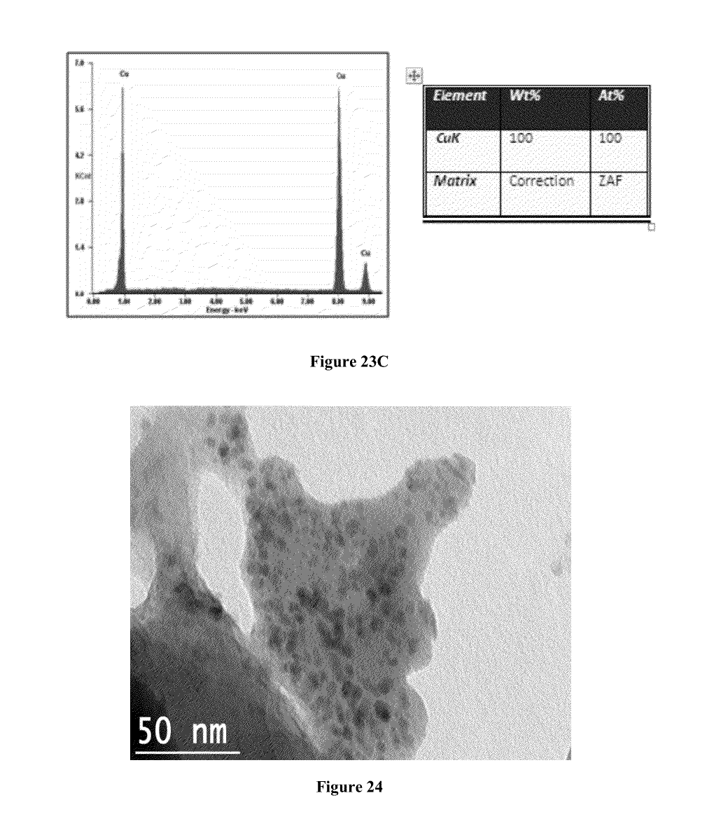

100 grams of copper sulphate is taken in the container of Aluminium. 20 gm of Adavitellagadda is added. After 15 minutes, copper nano powder is deposited in the container giving yield of 98%. Then this powder is washed by lime juice to get a purity of 100%.The size of the copper nano particles are measured and found to be 93 nm. FIG. 23(a) shows XRD patterns of copper nano particles; FIG. 23(b) shows the particle size analyser of the copper nano particles; and FIG. 23(c) shows energy dispersive X-Ray analysis of copper nano particles.

### Example 43

25 grams of copper sulphate is taken in the container of Aluminium. Tellachitrmulam is added. After 15 minutes, copper nano powder is deposited in the container giving yield of 98%. Then this powder is washed by lime juice to get a purity of 99%. The size of the copper nano particles are measured and found to be 81 nm.

### Example 44

100 grams of copper sulphate is taken in the container of Aluminium. Maruvam is added. After 15-30 minutes, copper nano powder is deposited in the container giving yield of 92%. Then this powder is washed by lime juice to get a purity of 100%. The size of the copper nano particles are measured and found to be 122 nm.

### Example 45

50 grams of copper sulphate is taken in the container of Aluminium. Sugandhavalakam is added. After 15 minutes, copper nano powder is deposited in the container giving yield of 91%. Then this powder is washed by lime juice to get a purity of 94%. The size of the copper nano particles are measured and found to be 57 nm. FIG. 24 shows the image of copper nano particles.

### Example 46

100 grams of copper sulphate is taken in an iron vessel. 10 gm of Gycchapatra is added to the sample. After 15 minutes, copper nano powder is deposited in the container giving yield of 79%. Then this powder is washed by lime juice to get a purity of 100%. The size of the copper nano particles are measured and found to be 67 nm.

### Example 47

100 grams of copper sulphate is taken in the container of Aluminium. Nagadhamani is added. After 15 minutes, copper nano powder is deposited in the container giving yield of 93%. Then this powder is washed by lime juice to get a purity of 98%. The size of the copper nano particles are measured and found to be 60 nm.

### Example 48

100 grams of copper sulphate is taken in the container of Aluminium. Kitamari is added. After 15 minutes, copper nano powder is deposited in the container giving yield of 93%. Then this powder is washed by lime juice to get a purity of 99%. The size of the copper nano particles are measured and found to be 70 nm.

### Example 49

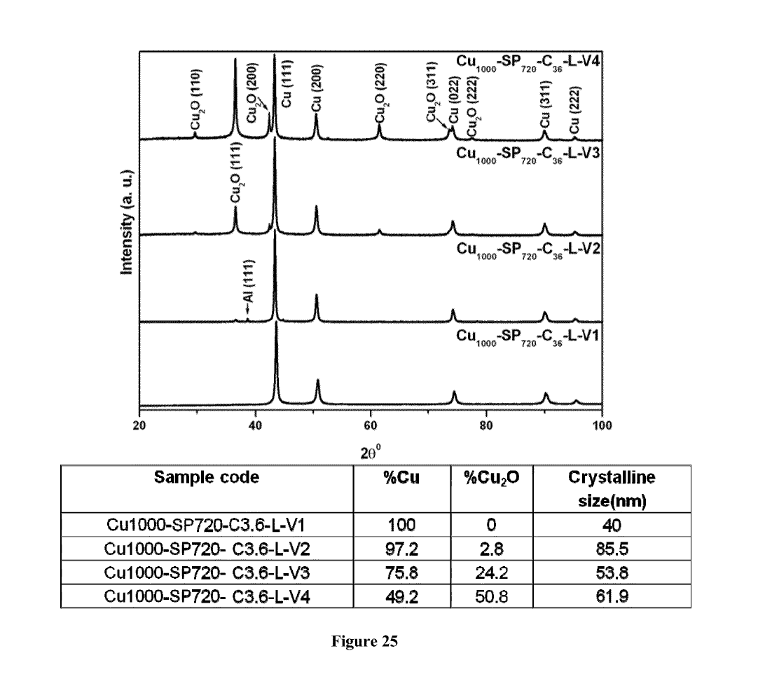

1000 grams of copper sulphate is taken in an iron vessel. 36 ml curd & 720 ml of soap nut are added to the sample. After 15 minutes, copper nano powder is deposited in the container giving yield ranging from 100% to as low as 48%. The effect of time of deposition was studied. The XRD pattern shows the formation of cuprous and copper oxide with increasing depostion time in 4 vessels named as V1, V2, V3, V4 in code respectively. low mentioned table explains this phenomenon in detail with monetary values to support the XRD pattern. Then this powder is washed by lime juice to get maximum purity. The size of the copper nano particles are measured and found to range between 40 nm to as high as 85.5 nm. FIG. 25 shows the graph for purity of nano copper particles.

### Example 50

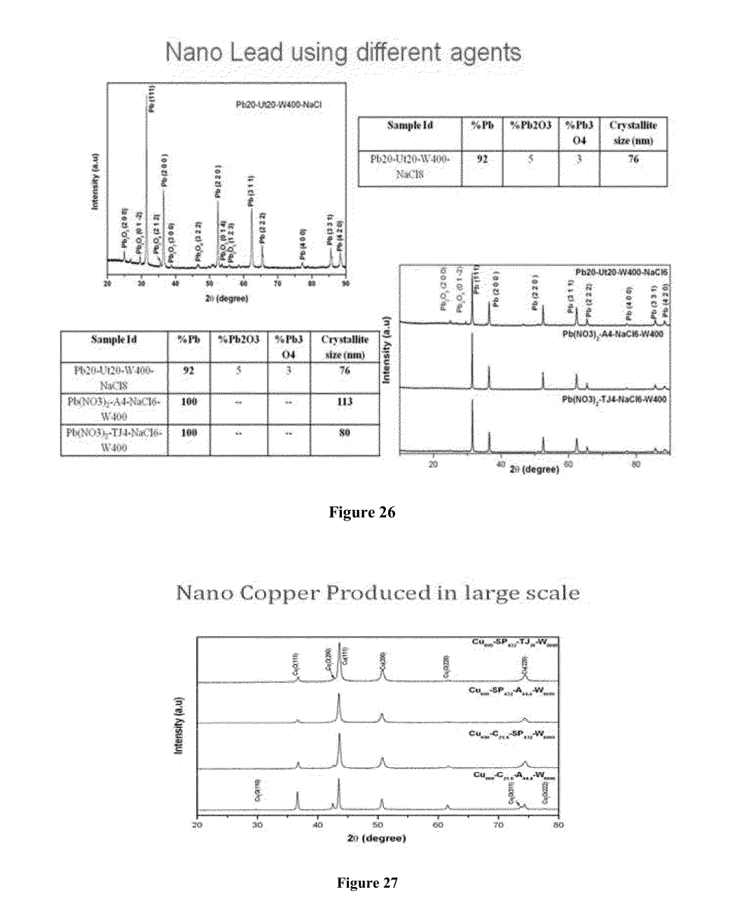

Effect of purity, yield, crystallite size of Nano Lead with usage of different surafce active agents: 20 gm of Lead nitrate is taken with varying quantites of surface active agents like 20 gm of uttareni and 8 gm of NaCl, 6 gm of NaCl with 4 gm of Amla, 6 gm of NaCl with 4 ml of Tamarind juice respectively. The effect of different surface avtive agents in combination with others was studied to check the yield, purity and crystalline size of the lead nano powder. The XRD images as in FIG. 26 shows the peaks of lead and Pb2O3 and Pb3O4 in combination with uttareni and NaCl but no traces of lead oxide were found with amla and tamrind juice in combination with NaCl. This concludes that uttareni in combination with NaCl forms oxides of lead and this methods can be adopted to manufacture lead oxides.

### Example 51

600 grams of copper sulphate is taken in an Aluminium vessel. 36 ml of Tamarind juice and 432 ml of soap nut, 432 ml of soap nut, 44.4 ml of amla, 21.6 ml curd & 720 ml of soap nut, 21.6 ml of curd and 44.4 ml of amla are added respectively to the sample. After 15 minutes, copper nano powder is deposited in the container giving yield ranging from 100% to 98%. The above experiment was done to check the sustenance of nano copper yield, purity and crystallite size even at larger production capacities which enables industrial production capacity. Only 1 to 2% of cuprous oxide formation was observed which was clearly shown in FIG. 27 XRD image.

The claimed novel properties of the nano products are tested and the results of the performed are explained below.

### TEST 1

### Wear Resistance Test of Copper

Thickness of coating=275-300 μm
Wear resistance of nano copper based paints is encouraging
Scratch test: scratch should not penetrate to base at 2 kg. The nano copper based paints do not show penetration to base metal even at 5 kg.

ASTM Wear Test
(1000 g-1000 cycles)

| | | Commercial |
|---|---|---|
| 90-10 | 60-40 | Paint |
| 35 mg | 58 mg | 50-75 mg |

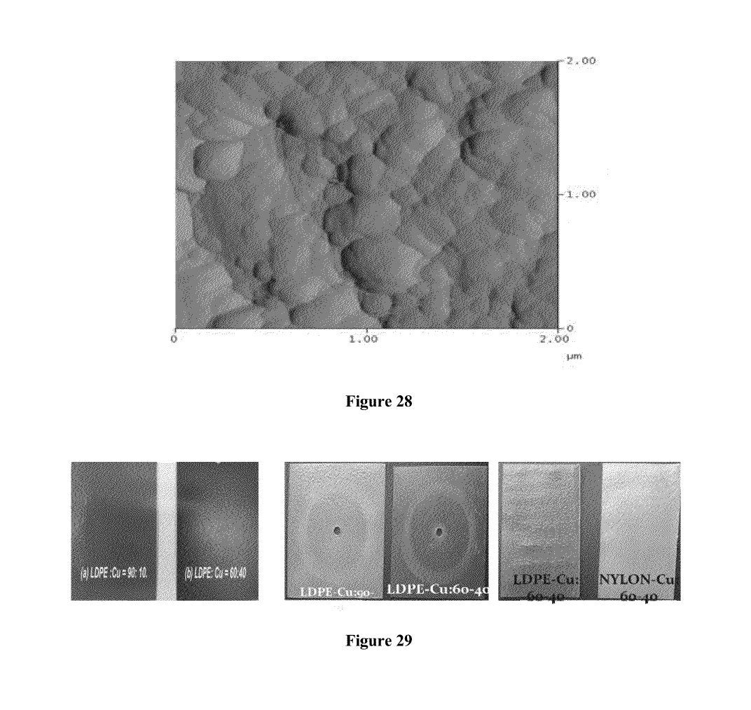

FIG. 28 shows nano copper powder after sintering at 500° C. and FIG. 29 shows the wear resistance of the copper nano poweder tested by Thermal Spraying of LDPE, NYLON and Nano copper on MS substrate.

### TEST 2

### Hardness Test

Vickers hardness testing showed that CV (nano copper prepared by vedic method) and CC (nano copper prepared by ball mill method) both had an average of about 70 HV (Vickers Hardness Number) with minimal standard deviation, while CSV (nano Cu—Sn prepared by vedic method) showed 267 HV standard deviation of and CSC (nano Cu—Sn prepared by ball mill method) had 167 HV (Refer the table below). The larger hardness value is a direct correlation of the structural properties. The smaller crystalline size of CV and CSV also means a greater amount of void spaces, (also seen in the atomic packing factor calculation), which were filled in by the increasing dislocations. Work hardening is the measure of the number of dislocations and CV and CSV had more dislocations along with compressive strain, there was an increase in the strength of the material when compared to CC and CSC.

| | Vickers Hardness (HV) | | | |
|---|---|---|---|---|
| | Vedic | Vedic | Commercial | Commercial |
| Trial | Cu | Cu—Sn | Cu | Cu—Sn |
| 1 | 69 | 304 | 67 | 172 |
| 2 | 69 | 292 | 70 | 173 |
| 3 | 71 | 269 | 73 | 170 |
| 4 | 71 | 263 | 75 | 164 |
| 5 | 72 | 272 | 70 | 167 |
| 6 | 73 | 274 | 68 | 167 |
| 7 | 70 | 272 | 71 | 168 |
| 8 | 70 | 266 | 70 | 167 |
| 9 | 69 | 269 | 70 | 172 |
| 10 | 70 | 286 | 71 | 166 |
| Average | 70 | 277 | 71 | 169 |
| Standard | 1 | 13 | 2 | 3 |
| Deviation | | | | |

### TEST 3

### Copper'S Electrical Conductivity

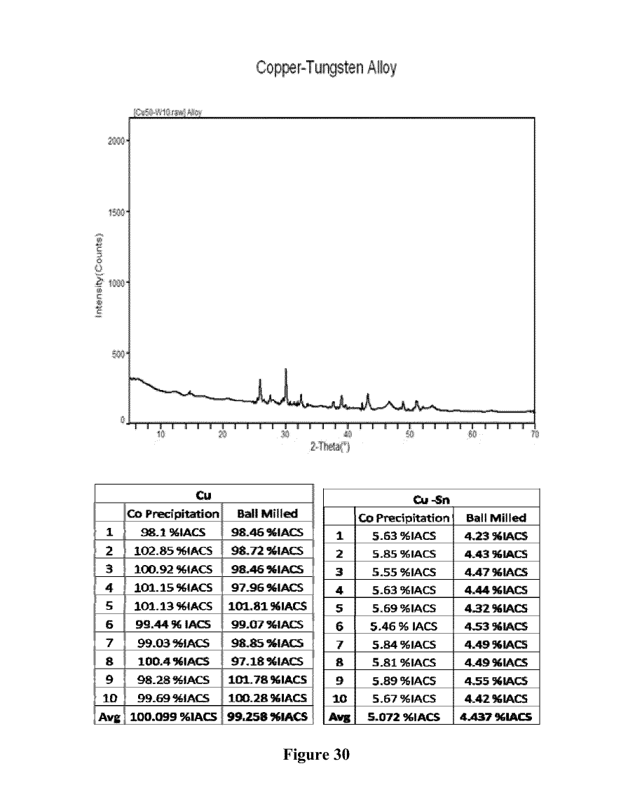

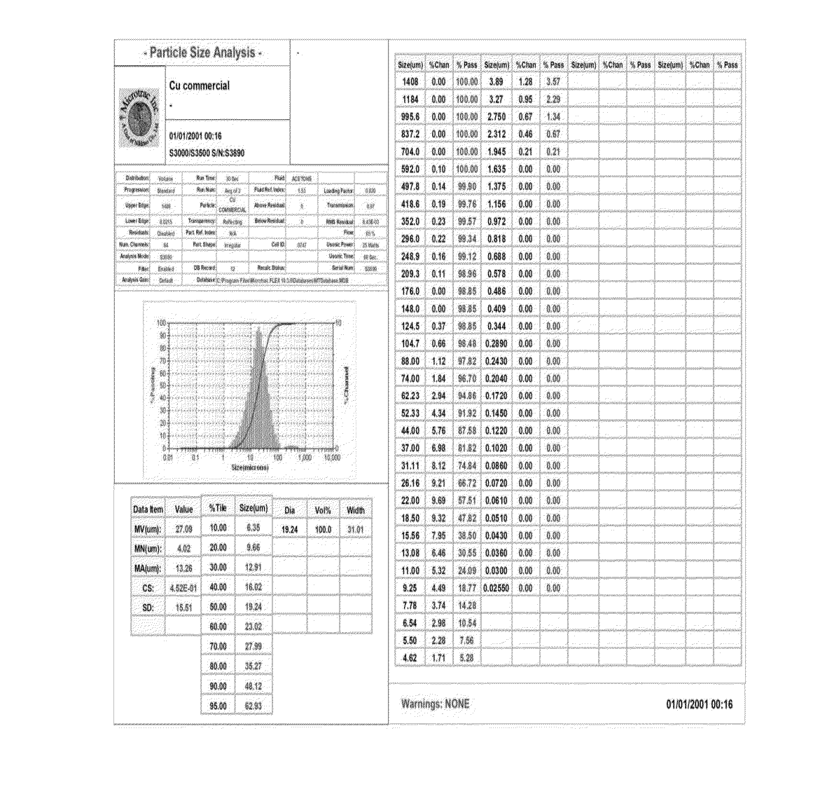

Copper's electrical conductivity is 100% IACS (International Annealed Copper Standard) and that of Cu—Sn is about 8% IACS, while that obtained through the conductivity test for CV and CC were about 75% each, and for CSV and CSC were 5% and 4% IACS respectively as shown in FIG. 30. This is most likely due to a decrease in the electrical conductivity as the grain size decreases, because there are more grains per unit volume, and thus more grain boundaries. The grain boundaries provide a high energy barrier, where the interatomic forces of attraction create high energy oscillation, and as describe earlier, the pinning effect of Sn along with its dielectrical effect provides resistance to the electricity. Although conductivity was decreased in all four samples, comparing hardness vs. conductivity it is observed that the decrease in conductivity is balanced by the increase in the hardness of the materials.

### TEST 4

### Particle Analysis

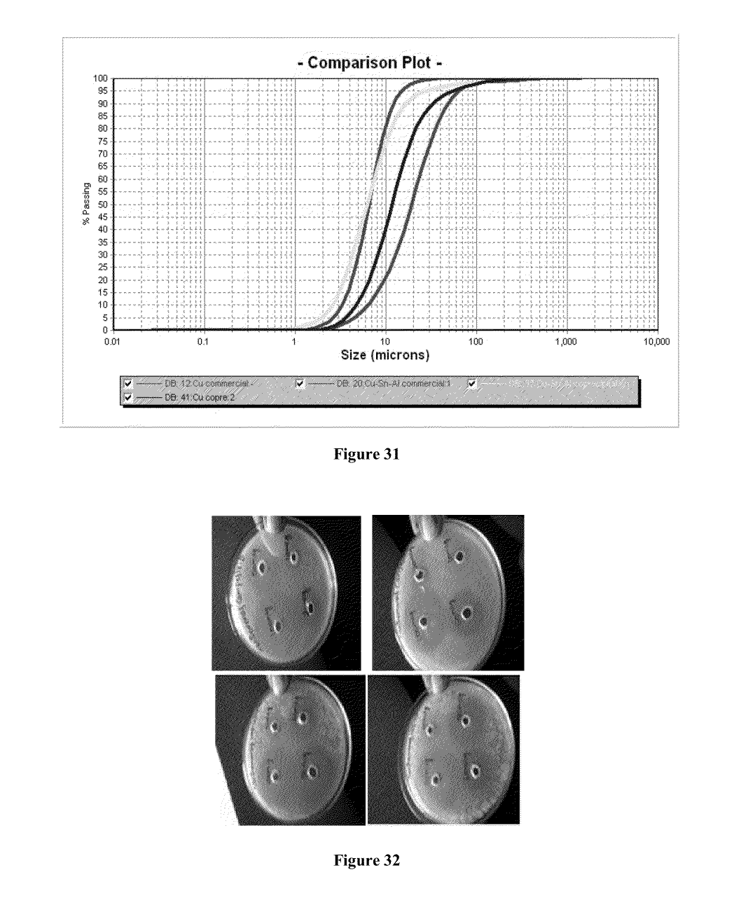

Particle size analysis gave me an idea of the larger framework containing these smaller compositions. Particle size analysis as showed in FIG. 31 illustrates that for CVP, CSVP, CCP, CSCP the particle size (in microns) values at 50% were 10, 5.9, 20, and 6.0, and the % channel peaks had nearly the same values. Thus it is observed that the particle size is nearly the same in CSV and CSC, while considerably different in CV and CC most likely due to the tight packing of Cu particles in Vedic synthesis. It is important to note that there are smaller grains and crystals contained within the same or even smaller particles. These smaller particles have circular grains with efficient surface area coverage on all sides of the grain, when compared to the larger particles. The atomic packing factor that is the ratio of the atomic sphere volume to the lattice sphere volume can give details about the amount of space left for diffusivity of Cu and Sn particles into Cu matrix. It is given by:

Atomic Packing Factor=NV/total lattice volume

Where N is the number matrix atoms and V is the total volume of the atoms, assuming their spherical. Taking the volume formula for a sphere and using 1.35 A for Cu and 1.405 A, the calculated APF (as a %) for CV and CSV is and 107.4637%, while that for CC and CSC is and 106.9414%. The reason for higher values than 100% is most possibly because Sn has dissolved into the Cu matrix, causing a contracting mechanism to result in an expansion of the crystal unit cube by a slight margin.

### TEST 5

### Herbal (Vedic) Copper Nanoparticles Anti Bacterial Activity on Xanthmonas

Method for Antimicrobial activity test: Materials used for antimicrobial activity of copper nanoparticles are Nutrient broth 1.3 g, Nutrient agar 2.8 g, Agar-agar 2 g, petriplates, Cotton swabs, xanthomonas axonopodis pv. Citri, Xanthomonas campestris pv. Vesicatoria. Diffusion method used for antimicrobial activity of copper nanoparticles.

Preparation of Inolculum: Nutrient broth (1.3 g in 100 ml D/W10) was prepared in 2 conical flasks and sterilized. In one conical flask clinically isolated strain of, xanthomonas axonopodis pv. Citri was inoculated. In the other conical flask clinically isolated strain of Xanthomonas campestris pv. Vesicatoria was added. These bacterial cultures inoculated in nutrient broth were kept on rotary shaker for 24 hrs at 100 r.p.m.

Inoculation of test plate: Nutrient agar is prepared (2.8 g nutrient agars, 2 g Agar-Agar in 100 ml distilled water) and sterilized. The agar suspension within 15 min is used to inoculate plates by dipping a sterile cotton-wool swab into the suspension and remove the excess by turning the swab against the side of the container. Then spread the inoculum evenly over the entire surface of the plate by swabbing in three directions.

Preparation of Antibiotic: 100 mg of copper nanoparticles added to 2 or 3 drops HNO3 solution, to this solution add 100 ml of water and make it to 1000 mcg. From 1000 mcg we prepared 10 mcg, 20 mcg, 50 mcg, 100 mcg for serial dilution.

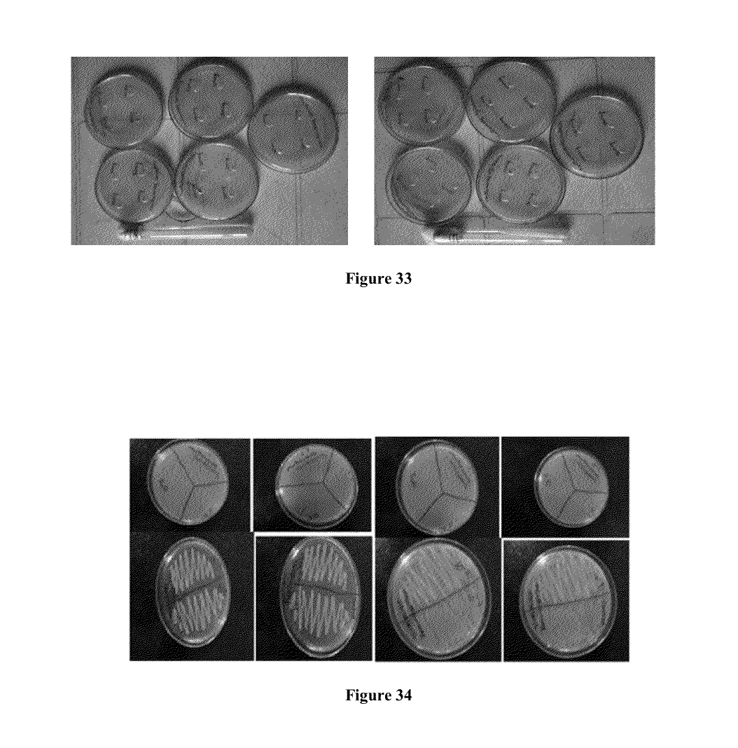

Diffusion method for Antimicrobial activity: Antibacterial tests were carried out by the well diffusion method using the suspension of bacteria spread on nutrient agar. Dip the swab into the broth culture of the organism. Gently squeeze the swab against the inside of the tube to remove excess fluid. Use the swab to streak agar plate or a nutrient agar plate for a lawn of growth. This is best accomplished by streaking the plate in one direction, then streaking at right angles to the first streaking, and finally streaking diagonally. We end by using the swab to streak the outside diameter of the agar. The inoculated plates were incubated at appropriate temperature for 24 hrs. The antimicrobial activity was evaluated by measuring the zone of inhibition against the test organisms. Finally we measure (mm) diameters of zones of inhibition of the control strain and test with a ruler, caliper. FIGS. 32 and 33 show the inoculated plates to measure the antimicrobial activity.

Minimum Inhibition Concentration test Result

| | | CONCENTRATIONS OF COPPER | | | |
|---|---|---|---|---|---|
| | BACTERIA | NANO PARTICLES IN (μG/ML) | | | |
| S.NO. | NAME | 10 μG | 20 μG | 60 μG | 100 μG |
| 1 | Xanthomaonas | 12 mm | 16 mm | 20 mm | 26 mm |
| | axonopodis pv.citri. | | | | |
| 2 | Xanthomonas | 11 mm | 15 mm | 20 mm | 25 mm |
| | campestris pv. | | | | |
| | Vesicatoria | | | | |

### TEST 6

### Minimum Bacterial Concentration Test

Method for Antimicrobial activity: Materials used for antimicrobial activity of copper nanoparticles are Nutrient broth 1.3 g, Nutrient agar 2.8 g, Agar-agar 2 g, petriplates, Cotton swabs, Xanthomonas axonopodis pv. Citri Xanthomonas campestris pv. Vesicatoria Minimum bacterial concentration method used for antimicrobial activity of copper nanoparticles.

Preparation of Inolculum: Nutrient broth (1.3 g in 100 ml D/W10) was prepared in 2 conical flasks and sterilized. In one conical flask clinically isolated strain of, Xanthomonas axonopodis pv. Citri was inoculated. In the other conical flask clinically isolated strain of Xanthomonas campestris pv. Vesicatoria was added. These bacterial cultures inoculated in nutrient broth were kept on rotary shaker for 24 hrs at 100 r.p.m.

Inoculation of test plate: Nutrient agar is prepared (2.8 g nutrient agars, 2 g Agar-Agar in 100 ml distilled water) and sterilized. The agar suspension within 15 min is used to inoculate plates by dipping a sterile cotton-wool swab into the suspension and remove the excess by turning the swab against the side of the container. Then spread the inoculum evenly over the entire surface of the plate by swabbing in three directions.

Preparation of Antibiotic: 100 mg of copper nano particles added to 2 or 3 drops HNO3 solution, to this solution add 100 ml of water and make it to 1000 mcg. From 1000 mcg we prepared 100 mcg for serial dilution. Often take a sample solution goes to serial dilution for 1 to 8 dilutions.

Minimum bacterial concentration method for Antimicrobial activity: Making the dilutions samples each one add 1 ml of bacterial solution, mixed with whole solution after 1 hrs streaking the prepare nutrient agar medium plates. The antimicrobial activity was evaluated by measuring the MBC test organisms growth in low concentration. FIG. 34 shows the inoculated plates to measure the antimicrobial activity.

Minimum Bacterial Concentration (MBC) Test Results

| | | Concentration of copper nano particles in(μg/ml) | | | | | | | | | |
|---|---|---|---|---|---|---|---|---|---|---|---|
| | Bacteria | | | | | | | | | | |
| S. No. | Name | 100 | 50 | 5 | 12.5 | 6.25 | 3.12 | 1.50 | 0.525 | 0.251 | Control |
| 1 | Xanthomaonas | Nil | Nil | il | Nil | Nil | Nil | Growth | small | good | Full |
| | axonopodis | | | | | | | starts | growth | growth | growth |
| | pv. citri. | | | | | | | | | | |
| 2 | Xanthomonas | Nil | Nil | il | Nil | Nil | Nil | Growth | small | good | Full |
| | campestris pv. | | | | | | | starts | growth | growth | growth |
| | vesicatoria | | | | | | | | | | |

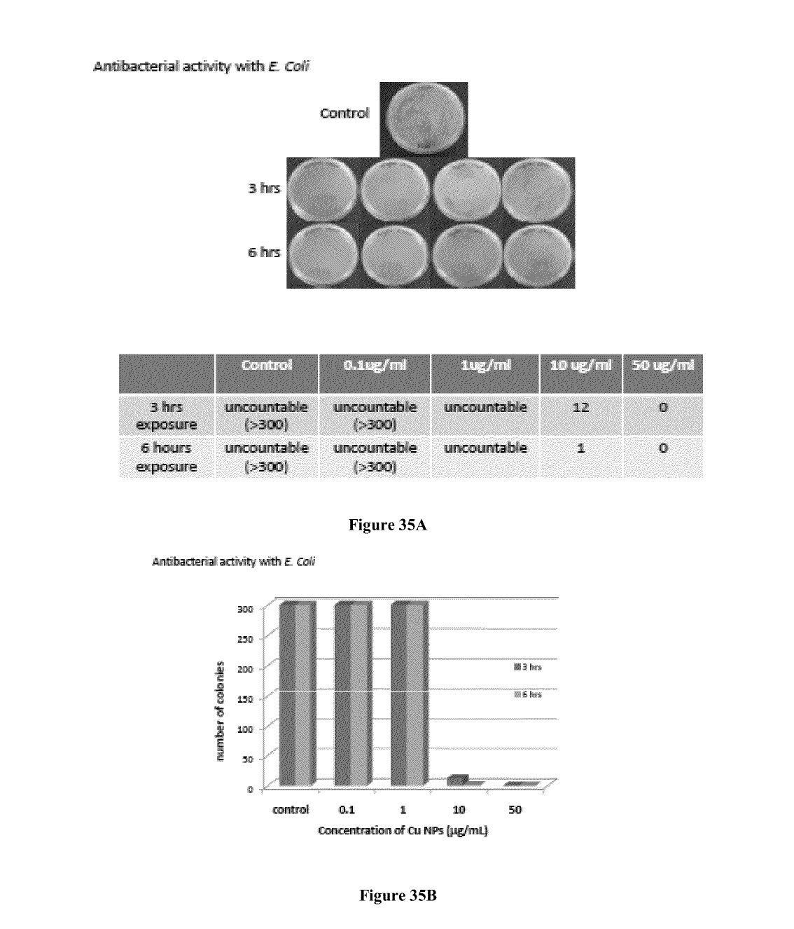

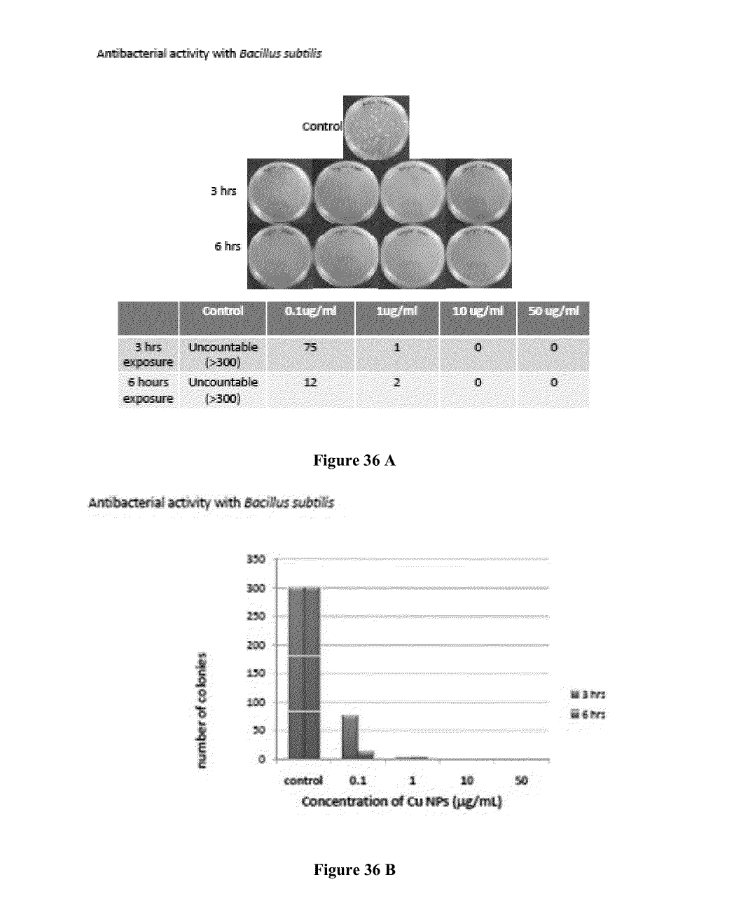

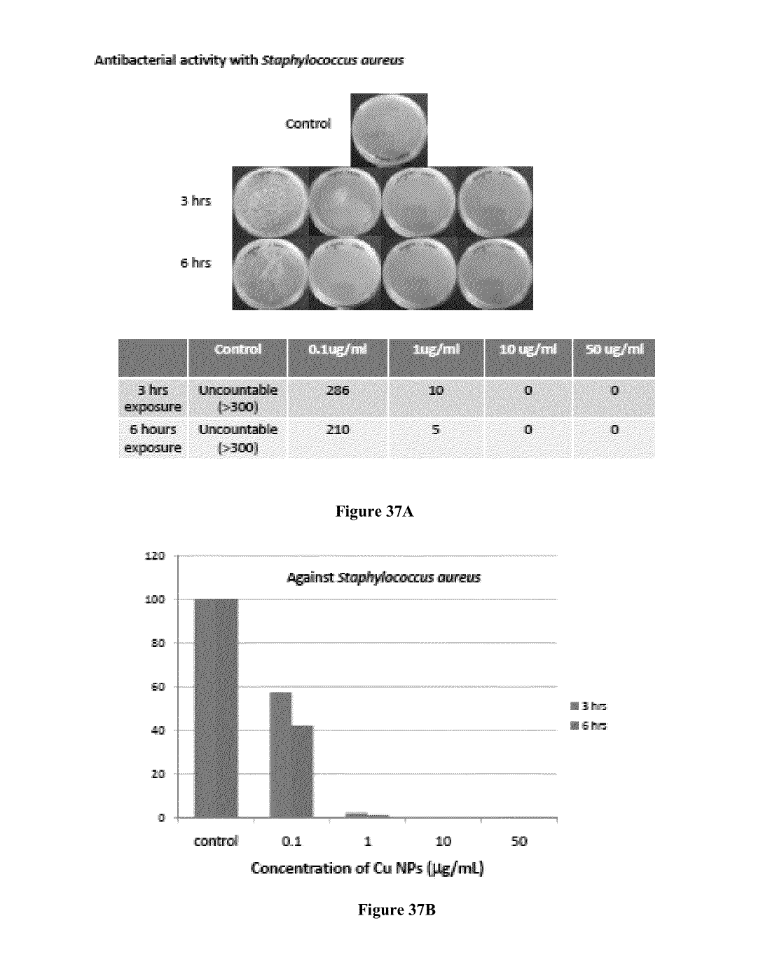

In addition to the above micro organism, the antibacterial activity of copper nano particles on E. Coli, Bacillus subtilis and Staphilococcus aureus are tested, the results of which are shown and tabulated in FIGS. 35, 36 and 37 respectively.

### TEST 7

### In Vitro Toxicity in Terms of Cyto Toxicity of Copper Nano Particles

Materials needed: Dulbecco's Modified Eagle's medium (DMEM); Fetal Bovine Serum (FBS); Phosphate Buffer Saline (PBS); Sodium dodesyl sulphate (SDS); (3-[4,5-dimethyl thiozol-2-yl])-2,5-diphenyltetrazolium bromide (MTT); Dimethyl sulfoxide. (DMSO); Water For Injection (WFI); and different concentration of nano particles.

Cell Culture: 3T3-L1 (mouse fibroblast cells), is a standard cell line widely used for testing early cyto toxic events. All cultures were maintained in a phenol red free culture medium DMEM/F12 (Dulbecco's modified essential medium/Ham's 12 nutrient mixture, Gibco), supplemented with 5% (v/v) fetal calf serum (JS Bioscience, Australia), and 1% (v/v) antibiotic (2 mM L-glutamine, 100 n/mL Penicillin and 0.1 mg/mL Streptomycin; Gibco). Cultured cells were kept at 37° C. in a humidified 5% CO2 incubator. Once the cells reached confluence, the culture medium was removed from the flask and the cells were rinsed three times with sterile HBSS (Hank's Balanced Salt Solution, Gibco). The confluent cell layers were enzymatically removed, using Trypsin/EDTA (Gibco, USA), and resuspended in culture medium. Cell viability was assessed by vital staining with trypan blue (0.4% (w/v); Sigma, USA), and cell number was determined using a light microscope.

Test articles preparation (Nanoparticles): Nanoparticles were prepared for cyto-toxicity test in physiological phosphate buffer saline (PBS) or deionized water. Based on the homogeneous dispersion studies using physical mixing and sonication, stock solutions were prepared either in PBS or deionized water. From this stock solution various concentrations were prepared in cell growth medium (Ham's Nutrient Mixture F-12) without serum. It was noted that turbidity increased with increasing concentration of nanomaterials. In order to ensure the uniform suspension, they were stirred on vortex agitation (1 min) before every use.

Test Groups: Negative Control. (Cells without nanoparticles); 0.1 μg/ml Nanoparticles from a) modern method and b) Vedic method; 0.5 μg/ml Nanoparticles from a) modern method and b) Vedic method; 1.0 μg/ml Nanoparticles from a) modern method and b) Vedic method; 2.0 μg/ml Nanoparticles from a) modern method and b) Vedic method; 5.0 μg/ml Nanoparticles from a) modern method and b) Vedic method; 10 μg/ml Nanoparticles from a) modern method and b) Vedic method; 15 μg/ml Nanoparticles from a) modern method and b) Vedic method; and 25 μg/ml Nanoparticles from a) modern method and b) Vedic method.

Cyto-toxicity Assay: Cytotoxic effects of different concentrations of nanoparticle preparations were assessed in a MTS cell proliferation assay using 3T3-L1 Mouse Fibroblast cells. PR-Omega Cell Titer 96 Aqueous Non-Radioactive Cell Proliferation (MTS) kit was used to determine the number of viable cells in culture. The test protocol for cyto-toxicity evaluation was adopted from previously published papers and manufacturer's instructions (Malich et al., 1997; Hayes and Markovic, 1999; Bakand et al., 2005a; Bakand et al., 2005b; Lestari et al., 2006; Hayes et al., 2007). Nanoparticles were suspended in culture media, serially diluted across 96-well microtiter plates (100 μL), and incubated at 37° C. with 5% CO2. Two sets of exposure times were carried. These included 4 h and 24 h exposure periods. Four hours prior to the end of each exposure period a MTS mixture (20 μL/well) was added. After the completion of exposure period, the plates were then placed on a micro well plate reader (Multiskan MS Lab system, Finland), shaken for 10 s and the absorbance of the formazan product was read at 492 nm. Each experiment was repeated on three separate occasions. Two internal controls were set up for each experiment: (1) an ICO consisting of cells only; and (2) IC100 consisting of medium only. Background absorbance due to the non-specific reaction between test compounds and the MTS reagent was deducted from exposed cell values (Hayes and Markovic).

Comparative MTT assay of copper nano particles with
different sizes and methods

| DOSE | | VEDIC |
|---|---|---|
| CONCENTRATION | MODERN | OR |
| OF COPPER NP | METHOD | HERBAL |
| (μG/ML) | (BALL METHOD) | METHOD |
| 0.1 μg/ml | 100% | 100% |
| 0.5 μg/ml | 94% | 97% |
| 1.0 μg/ml | 86% | 91% |
| 2.0 μg/ml | 78% | 88% |
| 5.0 μg/ml | 65% | 76% |
| 10.0 μg/ml | 42% | 63% |
| 15.0 μg/ml | 27% | 52% |
| 20.0 μg/ml | 15% | 33% |
| 25.0 μg/ml | 5% | 25% |

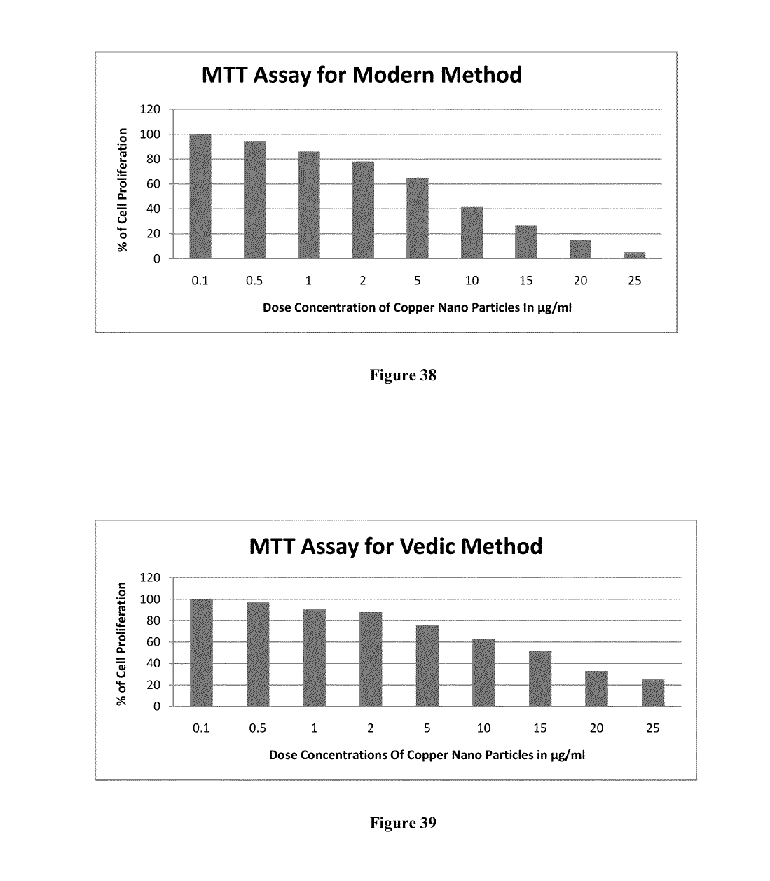

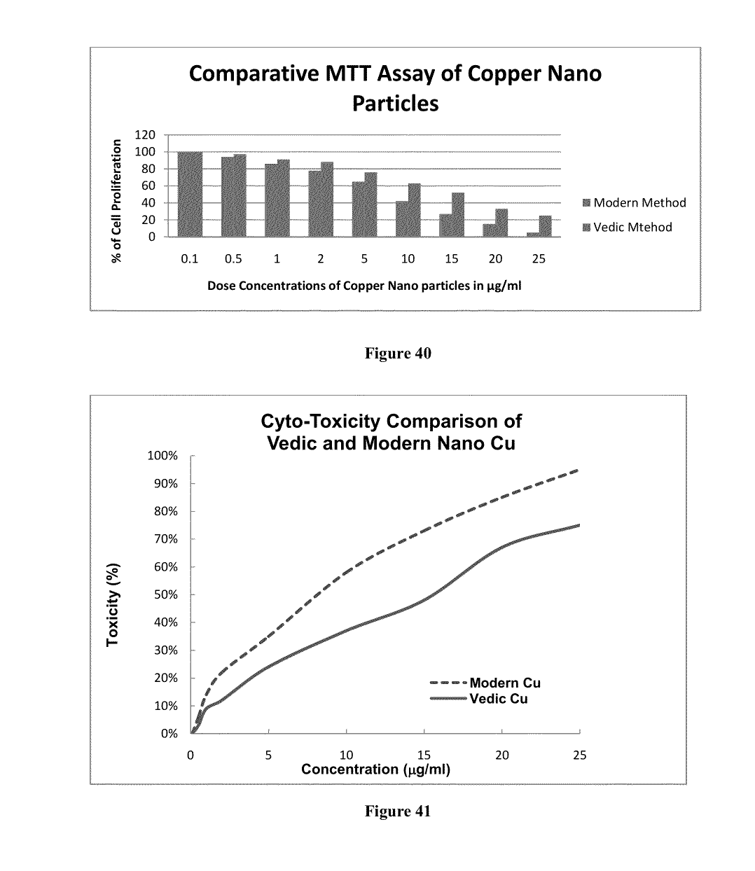

Results: The results shows that exposure to copper nanoparticles which were prepared by two different procedures, for a period of 24 to 48 h has resulted in concentration-dependent cyto toxicity on mouse fibroblast cells. It was noted that statistically significant difference were observed in level of cell proliferation between two methods of preparation. Cytotoxic effect was more pronounced in Modern method whereas Vedic method has exhibited less cyto toxicity. In Modern method cell proliferation is 5% at highest concentration i.e. 25 μg/ml, whereas at similar concentration Vedic method preparation has 25% cell viability. The exposure concentrations i.e. 0.1 μg/ml to 25 μg/ml was selected based on the therapeutic doses of nanoparticles. The lowest concentration of 0.1 μg/ml did not show any cytotoxic effect in both methods of preparation. Based on these results the most toxic material was the nanoparticle prepared from modern method. Vedic method preparation seems too significantly less toxic in terms of cell proliferation. FIGS. 38 and 39 shows the MTTT assay for copper nano particles prepared by ball milled method and vedic method. FIG. 40 illustrates the graph indicating comparative MTT assay of copper nano particles prepared by both methods. FIG. 41 illustrates the cyto-toxicity comparison of copper nano particles prepared by ball milled and vedic method.

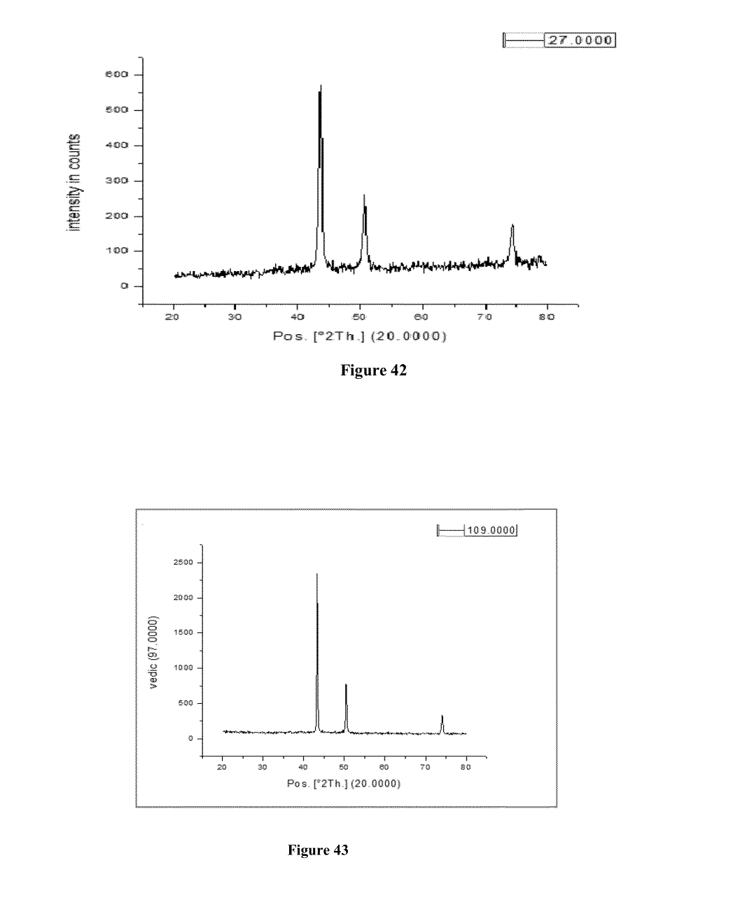

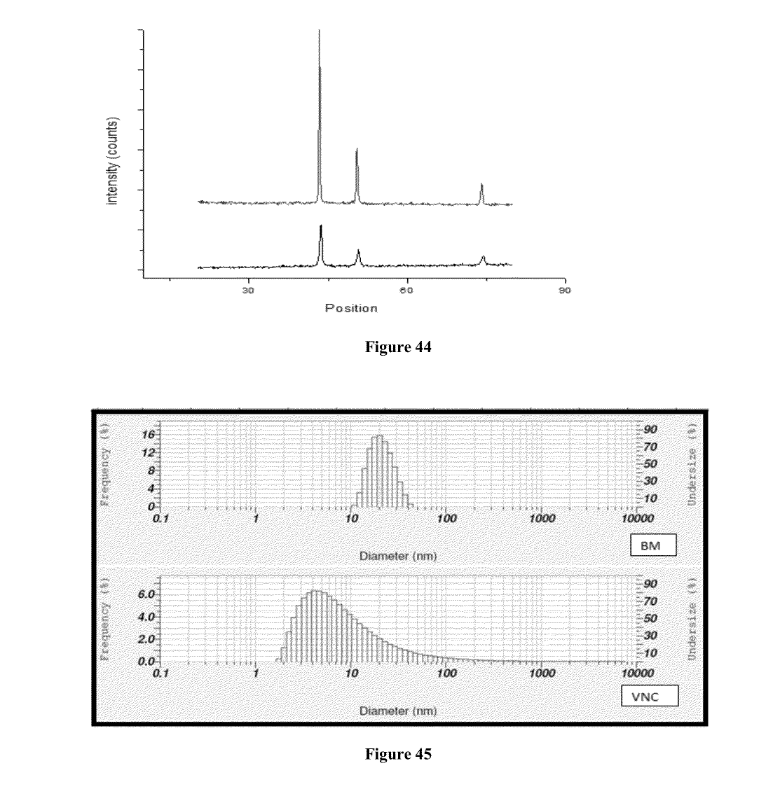

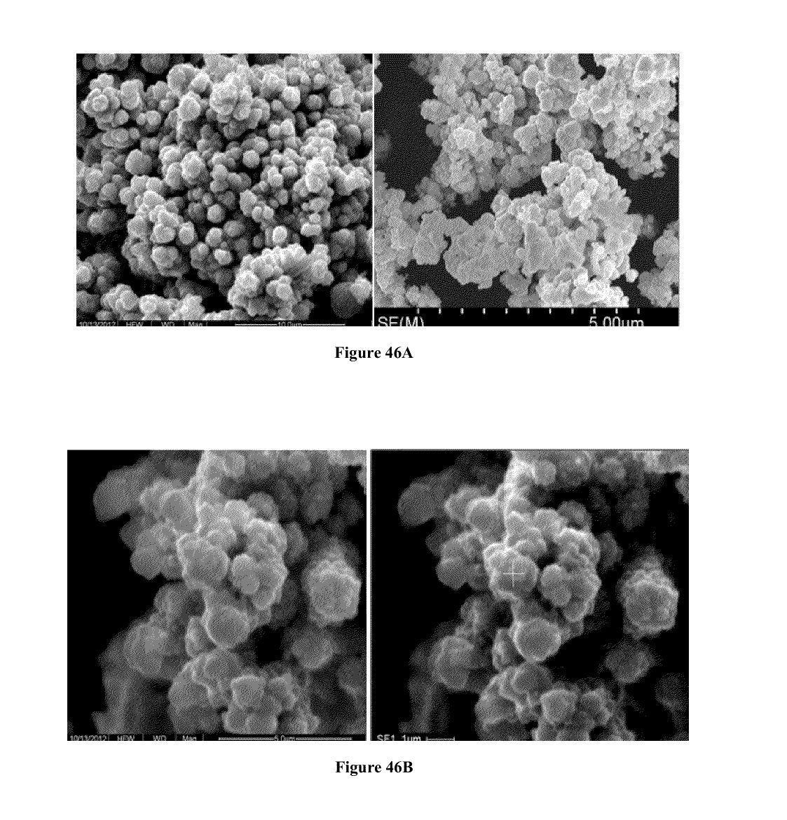

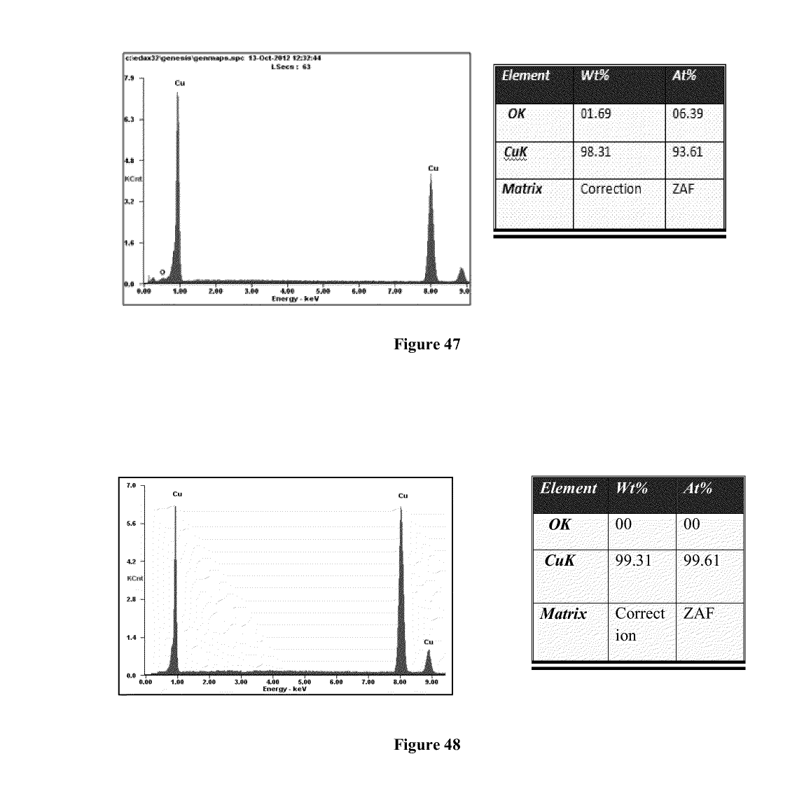

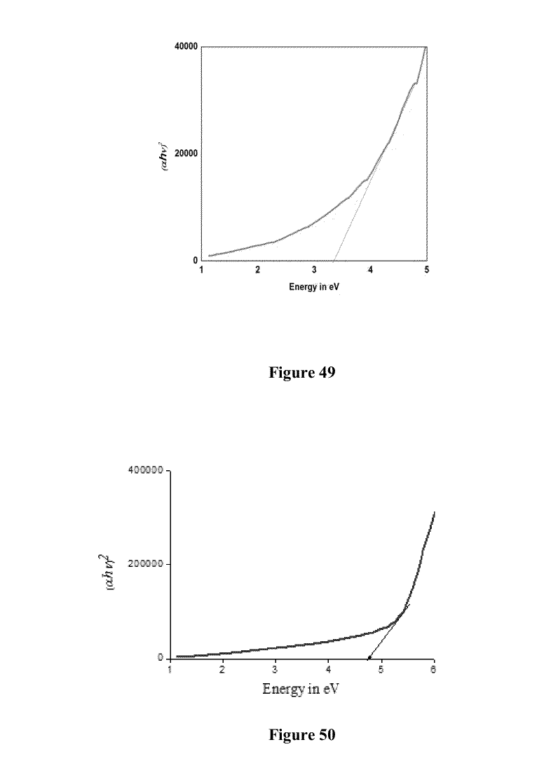

In addition to the above mentioned method of measuring cytotoxicity of the nano copper particles, the comparative studies on toxicity of copper nano particles in terms of invitro cyto-toxicity, which is synthesized by both modern and vedic method are explained. FIGS. 42 and 43 show the XRD results of ball milled copper nano particles and XRD results of vedic copper nano particles. FIG. 44 shows the compression between ball milled and vedic copper nano particles. FIG. 45 illustrates the particle size analysis of ball milled and vedic copper nano particles. FIG. 46 (a) and (b) show the SEM results of ball milled and vedic copper nano particles respectively. FIGS. 47 and 48 show the EDX spectra for vedic nano partilcles of ball milled and vedic copper nano particles. FIGS. 49 and 50 illustrate the UV-Vis spectra of ball milled and vedic copper nano particles respectively.

I claim:

1. A novel process of preparing metal nano powders using a natural ingredient selected from the group comprising of herbal extracts, plant extracts, water, milk or milk products, comprising the steps of
a. combining the natural ingredient with a metal salt in a metal container
b. allowing the nano powder to form and deposit
c. obtaining the nano powder

2. The process as claimed in claim 1, wherein the nano powder is a metal nano powder or alloy nano powder.

3. The process as claimed in claim 1, wherein the natural ingredient is selected from the group comprising of Curcuma aromatic, Alpiniacalcarta, Indigiferatinctoria, Spilanthusacmella, Pelargonium gravcolens, Mirabilis jalapa, Withanaisomnifera, Bacopamonnuri, Centellaasiastica, Rauvolfia serpentine, Acoruscalamus, Andrographispaniculata, Zingiberofficinale Cissusrepens, Apiumgraveolens, Steaviarebaudiania, Caralluma umbellate, Jatropha multi fida, Symplocosracemosus, Cymbopogonwinterianus, Curcuma longa, Abelmoschusmoschatus, Mucuna cochin, Daturametel, Helectersisora, Tinosporatomentos, Desmodiumgangeticum, Ipomoea balatas, Scillahyacinthiana, Plumbagozeylanica, Marjoranahortensis, Notoniagrandiflora, Plectranthusambonicus, Menthe piperita, Costusspeciosus, Rutachalepensis, Alpinia galangal, Kaempferia rotunda, Aremisia vulgaris, Anisomelesmalabarica, Aristolochia bracteolate, Vincarosea, Elettariacadamomum, Calotropisprocera, Psoraleacorylifolia, Paederiafortida, Riveahypocrateriformis, Ichnocarpusfrutescens, Piper longum, Aeglemarmelos, Opuntiadillenii, Euphirbiatirucalli, Sourops androgynous, Tylophoraindica Adhatodazeylanica, Asparagus racemosus, Abrusprecatorius, Phyllanthusamarus, Vativerizizanioides, Tinosporacordifolia, Gymnemasylvestre, Acimumtenuiflorum, Nyctanthes arbor tritis, Aratbotryshexapetalus, Phonixdactylifera, Pandanusodoratissimus, Cassia alata, Ocimumbusilicum, Alangiumsalnifolium, Carissa carandas, Jatrophagossypifolia, Lawsoniainermis, Bixaorellana, Mimosa pudica, Commiphoramukul, Buteamonosperma, Piper betle, Daturafatuosa, Aervalanta, Stachytarphetajamaicensis, Area catechu, Stachytarpheta, Cocculushirsutus, Ocimumgratissimum, Solanumnigrum, Eclipta prostrate, Cissusquadragulasis, Aloe vera, Curcuma amada, Curculigiorchioides, Leptadenia reticulate, Justiciagendarussa, Ocimum sanctum, Celastruspaniculate, Passifloaedulus, Vitexpurpurescense, Holostemmeadakodien, Achyranthusaspera, Gmelinaarborea, Oroxylumindicum, Stereospermumsuaveolens, Bauhinia variegate, Caesalpiniasappan, Givotiarotteleriformis, Cordial dichotoma, Adina cordifolia, Baringtoriaacutangula, Hard wickia binate, Dalbergialatifolia, Ficustomentosa, Holarrhenapubescens, Bosnelliaserata, Couroupitaguianens, Albiziaodoratissima, Plerocarpusmarsupium, Hymenodictyonexcelsum, Litseaglutinosa, Mitragynaparvifolia, Cochlnospermumreligiosum, Dichrostachyscinerea, Syzygiumcumini, Crescentiacujette, Ficuscarica, Prosopis cineraria, Morindacitri folia, Pterocarpusofficinalis, Abutilon indicum, Cinnamomumzeylanium, Cymbopogonfexuosus, Citrus medica, Semecarpusanacardium, Clitoriaternatea, Decalepishamiltonii, Rosemarinusofficinalis, Rauvolfia tetra ohylla, Jasminumsambac, Elaeocarpusganitrus, Saracaasoca, Terminaliabellerica, Terminaliachebula, Sterculiaurens, Amaranthaceae, Pelargonium, Polypodiumleucotomos, Cyndoniaoblonga, Aloe ferox, Vaccinumangustifolium; Dicotyledonous, Lonicerarnaacki, Illiciumverum, Vaccinumangustifolium, Tamarindusindica, Emblicaofficinalis, Citrus auratium, Sapindusmukorossi, Tribulusterrestris, Triticumaestivum, Citrulluslanatus, Triticumaestivum, Citrulluslanatus, Mangiferaindica, Solanummelongena, Oryza sativa, SacharumOfficinarum, Solanumtuberosum, Punicagranatum, Aronia, Vacciniummyrtillis, Prunus Americana, Malusdomestica, Helianthus annuus, Solanumlycopersicum, Malusdomestica, Pisumsativum, NicotianaTabacum, Solanumlycopersicum, Gossypiumhirsutum, Musa, Vitisvinifera, Pipernigrum, Rosa canina, Citrus tangerine, Yucca brevifolia, Zea mays, Helianthus annuus, Daucuscarota, Carthamustinctorius, water, milk or milk product.

4. The process as claimed in claim 3, wherein the water is either De-mineralized or tap water or potable water with any type and percentages of salts present in water either in individual or compound or alloy form.

5. The process as claimed in claims 1 and 3, wherein the natural ingredient of herbal extract or plant extract is used in powdered form or paste form or juice form or in its original form or mixed with water at any percentage levels.

6. The process as claimed in claims 1, 3 and 5, wherein the natural ingredient is used either solely or in combination with one or more herbal extract or plant extract such as herein described.

7. The process as claimed in claim 1, wherein the metal comprising the metal salt is selected from the group comprising of C, Mg, Al, Si, Ti, Cr, Mn, Fe, Co, Ni, Cu, Zn, Y, Zr, Ag, Cd, Sn, Sb, W, Au, Hg, Pb, Bi, or alloys or bimetals thereof.

8. The process as claimed in claims 1 and 7, wherein the metal salt is selected from the group comprising of oxides, sulfides, silicates, nitrates, nitrides, sulphates, chlorides or any other metal salt.

9. The process as claimed in claim 1, wherein the nano powder obtained is washed until impurities are removed.

10. The process as claimed in claims 1 and 9, wherein the washed nano powder is further washed with Lime or extracts from lime or chemicals rich in citric acid or chemicals which contain citric acid as one of it functional group or citric acid alone

11. The process as claimed in claims 1 and 10, wherein the obtained nano powder is vacuum dried.

12. The process as claimed in claims 1, wherein the natural ingredient is combined with metal salt for a time in the range of 1-18 minutes.

13. The process as claimed in claim 12, wherein the natural ingredient is combined with metal salt for preferably 12 minutes.

14. The process as claimed in claim 1 where the metal of the container is selected from the group comprising of C, Mg, Al, Si, Ti, Cr, Mn, Fe, Co, Ni, Cu, Zn, Y, Zr, Ag, Cd, Sn, Sb, W, Au, hg, Pb, Bi, or alloys or bimetals thereof.

15. The process as claimed in claim 1, wherein the yield of the nano powder is 75-90% and the purity is in the range of 98-100%

16. Nano powder and the intermediary nano products like nano metal oxides, nano metal carbides, nano metal compounds, nano metal fluids and nano metal composites produced by the process of the preceding claims.

17. The products as claimed in claim 16, wherein the powder is metal nano powder or alloy nano powder.

18. The products as claimed in claim 16, wherein the particles size of the nano powder in the range of 0.1 nm-1.00 nm.

19. The products as claimed in claim 16, wherein they have an organic compound by way of coating which is produced with the use of natural ingredient.

20. The products produced by the process of claim 1, wherein they are capable of preventing oxidation, withstand high temperatures, wear resistant, abrasive resistant, display superior frictional properties, sliding wear resistance, high electrical and thermal conductivity, antibacterial removal properties, corrosion resistance, enhanced hardness and strength, enhanced tensile and compression properties, load bearing capacity applications when compared to nano powders produced under conventional method.

21. Use of the nano powder as claimed in any of the preceding claims to prepare thermal fluids, anti-fungal/bacterial/fouling coatings, paints, high strength electrical conductors, high corrosion resistant coatings & alloys, inkjet inks, neutralizing gram positive bacteria, neutralizing gram negative bacteria, motor cycle clutch, rocker arm, solder materials, bearing applications, spring materials, automobile parts, steering wheel joints and coatings, connecting rod, memory enhancing devices (viz, hard disks, pen drives etc), electronic chips, smart materials, shape memory alloys, add-on materials for composite lamina or laminates of any number etc.

22. A Process, product prepared from such process and use of the process and product substantially as herein described with reference to the claims and attached figures.
